(19) United States
(12) Patent Application Publication
(10) Pub. No.: US 2006/0148550 A1
(43) Pub. Date: Jul. 6, 2006

(54) Auditing data transfers in electronic game device systems

(76) Inventors: Patrick W. Nee JR., Greenwich, CT (US); Robert C. Tedesco, Fairfield, CT (US); Brian J. Besterman, South Salem, NY (US)

Correspondence Address: WALKER DIGITAL, 2 HIGH RIDGE PARK, STAMFORD, CT, 06905, US

(21) Appl. No.: 11/343,000

(22) Filed: Jan. 30, 2006

(51) Int. Cl. A63F 9/24; G06F 19/00

(52) U.S. Cl. 463/16

(57) ABSTRACT

Methods and systems for auditing data transfers in electronic game device systems are described. In embodiments, the method includes determining gaming request audit data for at least one electronic game device that includes information identifying at least one responsive electronic game server. The audit data may also include at least one of an indication of the time and date of a gaming request and a transaction identifier. The method also includes storing the gaming request audit data in at least one searchable memory.

### FIELD OF THE INVENTION

The present invention generally relates to methods and apparatus for auditing Electronic Game Devices (EGD's). In particular, methods and apparatus are presented for auditing EGD requests for gaming instructions and gaming results that are fulfilled by one or more Electronic Game Servers (EGS's) of a network.

Advantages and features of the invention will become apparent upon reading the contents of this document, and the nature of the invention may be more clearly understood by reference to the following detailed description of the invention, the appended claims and to the drawings attached hereto.

### BRIEF DESCRIPTION OF THE DRAWINGS

FIG. 1A is a plan view of an embodiment of an example of an Electronic Game Device (EGD) of a type adapted for use with the present invention;

FIG. 1B is a simplified block diagram of an embodiment of an EGD similar to that depicted in FIG. 1A;

FIG. 1C is a simplified block diagram of an embodiment of an Electronic Game Server (EGS) in accordance with the invention, wherein the EGS is configured to communicate with a plurality of EGDs;

FIG. 2A is a block diagram of a system in accordance with at least one embodiment of the invention;

FIG. 2B is a block diagram of another system according to at least one embodiment of the invention;

FIG. 2C is a simplified schematic diagram of yet another embodiment of a system according to the invention;

FIG. 3 is a flowchart illustrating an embodiment of the operation of an EGD in a system in accordance with the invention;

FIG. 4A is a sequence diagram illustrating a process for storing audit data in a Central Audit Database according to an embodiment of the invention;

FIG. 4B is a sequence diagram illustrating a process for storing audit data in a Central Audit Database according to another embodiment of the invention;

FIG. 5 is a tabular representation of an embodiment of an audit database according to the invention; and

FIG. 6 is a simplified view of a Graphical User Interface (GUI) illustrating an example of search results to a query for audit data in a system in accordance with the invention.

### DETAILED DESCRIPTION OF THE INVENTION

Applicants have recognized that large-scale deployments of networked Electronic Game Devices (EGDs) will require significant computing power, and that large installations may implement the idea of a single logical Electronic Game Server (EGS) that transmits the gaming computations and instructions by utilizing multiple physical Electronic Game Servers (EGS's). In addition, a multi-layer architecture (such as Model-View-Controller) may be used that may result in more than one logical grouping of functions in the EGS implementation. In these implementations, a single request for game play from an EGD can be satisfied by a large number of possible combinations of physical devices such as EGS's. Regulatory requirements dictate that every EGD maintains an audit trail of recent outcomes played on the device. In traditional environments, it can be inferred that the computer or processor residing in the device performed the calculations, and anomalous outcomes can therefore be easily investigated by reviewing the memory contents associated with the processor of that EGD. In thin client architectures, however, there is a need for a process or system for identifying which physical EGS or combination of EGS's satisfied a gaming request and/or generated gaming results for an EGD. A “gaming request” is a solicitation by an EGD for data that will be used to formulate at least a portion of a gaming outcome. For example, the EGD may make a gaming request for five cards, for three icons representing a combination for display for a three-reel slot machine, for the generation of random numbers, and/or for a mapping of random numbers to game parameters such as cards, dice, reel icons and the like.

Thus, there exists a need for a method and apparatus for recording the identity of, and optionally the results generated by, the physical EGS or combination of EGS's that responded to a particular request for computation made by an EGD.

Some embodiments of the present invention relate to improvements in recording data that identifies the physical Electronic Gaming Server or combination of EGS's that provided gaming results for, and/or that responded to requests made by, an Electronic Gaming Device. Various embodiments of systems and methods are described herein that generate and provide audit data identifying the EGS or group of EGS's that provided particular instructions and/or results to a particular EGD. Some embodiments concern the type of audit data to store in a database or other memory scheme, and making such audit data or portions thereof accessible to certain persons such as authorized personnel, casino regulators, and/or to players.

In an embodiment, a thin-client architecture is adapted for the networked EGDs. Such a thin-client gaming system is characterized by an organization of computations on a plurality of computers in which the presentation (i.e., the graphic display) of game play is performed on devices that are separate from some or all of the devices performing computations for generating the game play. It should be understood that, in such thin-client systems, the division of computations between the display device and other devices is on a continuum. Thus, in one extreme embodiment, the EGD is similar to a dumb terminal wherein virtually no game computations are performed, so that one or more Electronic Game Servers (EGS's) provide virtually all of the instructions and data. In another extreme embodiment an EGD may perform all but a single computation. For example, the EGD may perform all computations except for the generation of random outcomes, which are provided by a physically separate server computer.

Systems and methods consistent with the present invention avoid the shortcomings of prior art systems by making it simple and easy for qualified personnel, regulators, and/or players to obtain and to analyze the audit data. The systems and methods also may include security provisions to make it difficult to modify the audit data, and/or to make it apparent that the audit data has been modified. Regulators, for example, may be able to access audit data to obtain a definitive picture of which EGD, EGS or group of EGS's was responsible for what gaming actions, results, and/or anomalies. In certain embodiments, regulators may also be able to determine whether or not the audit data was tampered with and who may have been responsible for such malicious activity.

Before describing the details associated with determining gaming request audit data that may be stored in a memory, presented are descriptions of illustrative apparatus, related components, and system architectures.

Electronic Gaming Device (EGD) Components

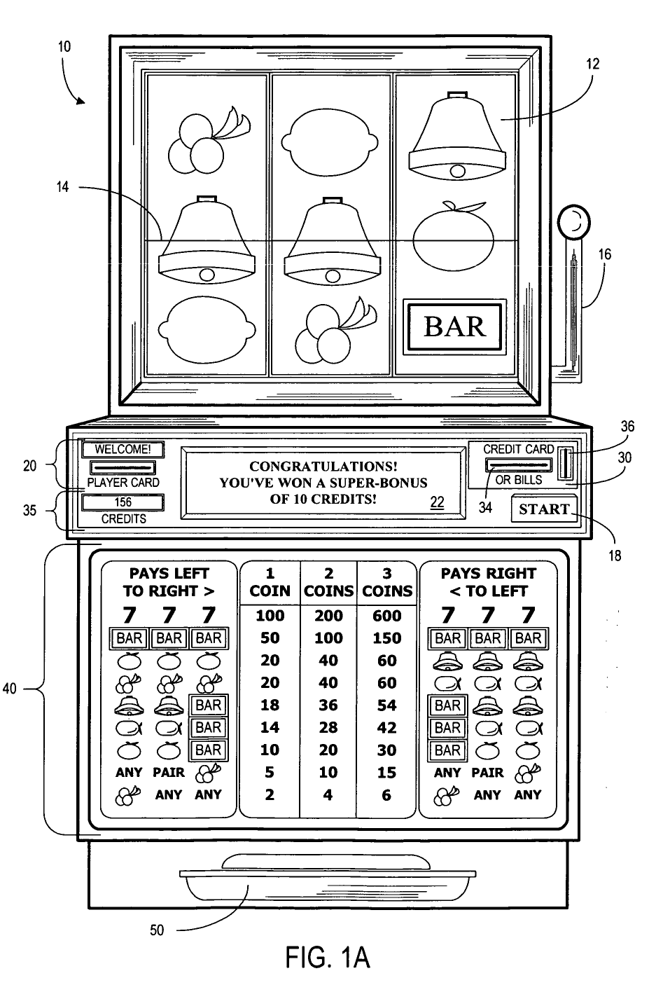

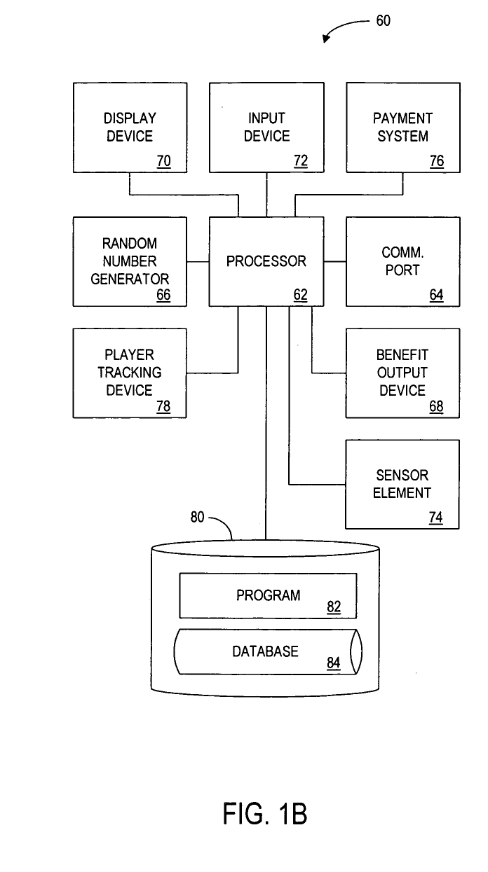

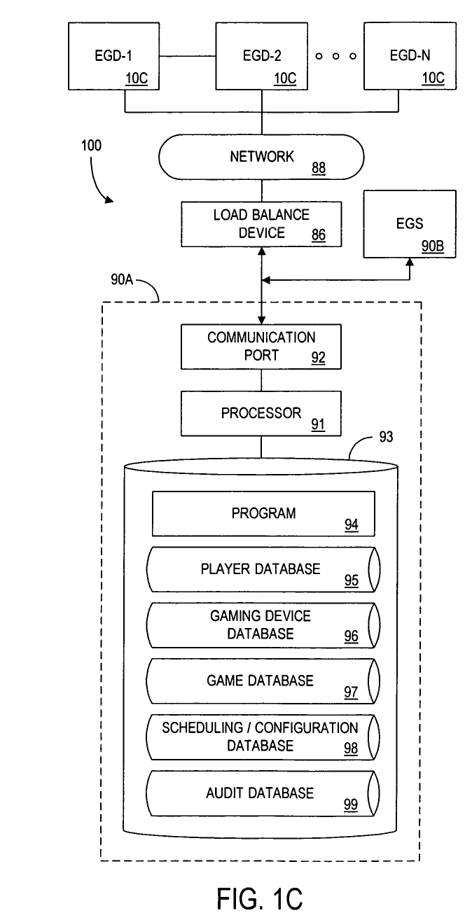

FIG. 1A is a plan view of an embodiment 10 of an electronic gaming device (EGD). In this example, the EGD 10 comprises a three-reel slot machine that includes a display area 12 in which an outcome for a game of the slot machine is displayed to the player. The display area 12 may be, for example, a video display that displays simulations of reels. The display area 12 may be, in another example, a transparent window behind which is located mechanical reels. A payline 14 appears within the display area 12, and the payline is used to determine the outcome of a game. In particular, a particular set of symbols displayed along a payline of a reeled slot machine may be determinative of a winning or losing combination. As shown in FIG. 1A, two bells and an orange are displayed along the payline 14 and a message appears in display area 22 indicating that the player has won a super bonus of ten credits.

Slot machine 10 further comprises a handle 16. A player may initiate the movement of the reels in display area 12 to generate a game outcome by pulling on the handle 16. Alternatively, a player may initiate the movement of the reels in display area 12 by actuating the start button 18. Either or both of handle 16 and start button 18 are exemplary embodiments of an input device of the EGD.

In this exemplary implementation, the slot machine 10 also comprises a player tracking device 20 that includes a player tracking card reader and a display (e.g., an LED display) for outputting information related to the player identifier (e.g., player's name and number of comp points associated with that player's account). The player tracking device 20 may be configured to read, for example, a magnetic stripe found on the reverse side of a player gaming card provided by a casino, and to write information thereto. In another example, the player tracking device 20 may be configured to communicate with a smart card that may include storage means for storing player data and the like.

An additional component of slot machine 10 is another display area 22 that may be used to display information to a player. The display area 22 may be utilized, for example, to display text or graphics that inform a player that he has qualified for a bonus or to convey other information to the player.

A payment system 30 includes a bill acceptor and credit card reader 34, and a coin acceptor 36. Other payment systems, such as ticket or coupon acceptors, and/or a smart card reader, could also be utilized. A player may utilize the payment system 30 to provide a wager for playing a game.

The slot machine 10 further comprises a credit meter balance 35 that reflects the amount of electronic credits currently available to a player. The player may use the electronic credits as wagers for games played on the gaming device. The electronic credits may also be “cashed out” as coins, bills, tokens, a cashless gaming receipt, and/or value transferred to another financial account associated with the player.

The slot machine 10 includes yet another display area 40, which displays a payout schedule of the slot machine 10. The payout schedule displays payouts that correspond to various outcomes obtainable on the slot machine 10. In one or more embodiments, if an outcome is displayed in display area 12 that, as indicated in display area 40, corresponds to a payout, the credit meter balance 35 may be increased by an amount of electronic credits corresponding to the payout.

Finally, the slot machine 10 comprises a coin tray 50 into which payment to the player may be rendered by dispensing coins. Such coins may be dispensed based on, for example, a player's indication that the player would like to cash out his credit meter balance and/or a payout obtained by a player as a result of playing a game on the slot machine 10. The coin tray 50 is an exemplary embodiment of a benefit output device (described below with reference to FIG. 1B).

FIG. 1B is a simplified block diagram 60 of an embodiment of an EGD or player terminal which may be similar to that of FIG. 1A. The EGD 60 may be implemented as a system controller, a dedicated hardware circuit, an appropriately programmed general-purpose computer, or any other equivalent electronic, mechanical or electro-mechanical device. The EGD 60 may comprise, for example, a reeled slot machine (whether mechanical or video), a video poker terminal, a video blackjack terminal, a video keno terminal, a video lottery terminal, a pachinko machine, or any apparatus that provides an electronic version of any tabletop game. In various embodiments, an EGD may comprise, for example, a personal computer (e.g., which communicates with an online casino Web site), a telephone (e.g., to communicate with an automated sports book that provides gaming services), or a portable handheld gaming device (e.g., a personal digital assistant (PDA), Nintendo GameBoy™, or SONY brand PSP™). In some embodiments, a user device such as a PDA or cell phone may be used in place of, or in addition to, some or all of the EGD 60 components depicted in FIG. 1B.

The EGD 60 of FIG. 1B includes a processor 62, such as one or more Intel® Pentium® processors, or similar processors manufactured by other companies such as the Advanced Micro Devices, Incorporated. The processor 62 is in communication with a memory 80 and a communication port 64 (e.g., for communicating with one or more other devices, such as with a peripheral device). The memory 80 may comprise an appropriate combination of magnetic, optical and/or semiconductor memory, and may include, for example, Random Access Memory (RAM), Read-Only Memory (ROM), a compact disc and/or a hard disk. The memory 80 may comprise or include any type of computer-readable medium. The processor 62 and the memory 80 may each be, for example: (i) located entirely within a single computer or other device; or (ii) connected to each other by a remote communication medium, such as a serial port cable, telephone line or radio frequency transceiver. In one embodiment, the EGD 60 may comprise one or more devices that are connected to a remote server computer, such as an EGS, for maintaining databases or data in another memory scheme.

The memory 80 stores a program 82 for controlling the processor 62. The processor 62 performs instructions of the program 82, and thereby operates in accordance with embodiments of the present invention, and particularly in accordance with the methods described in detail herein. The program 82, as well as any other program for controlling a processor described herein, may be stored in a compressed, uncompiled and/or encrypted format. The program 82 furthermore includes program elements that may be necessary, such as an operating system, a database management system and “device drivers” for allowing the processor 62 to interface with one or more computer peripheral devices. Appropriate program elements are known to those skilled in the art, and need not be described in detail herein.

According to an embodiment, the instructions of the program 82 may be read into a main memory from another computer-readable medium, such from a ROM to RAM. Execution of sequences of the instructions in program 82 may cause processor 62 to perform one or more process steps described herein. In alternate embodiments, hard-wired circuitry may be used in place of, or in combination with, software instructions for implementation of some or all of the processes of the present invention. Thus, embodiments described herein are not limited to any specific combination of hardware and software.

The memory 80 may also store one or more databases 84, or portions thereof. For example, the database 84 of memory 80 may be one or more of a probability database, a payout database, and/or an audit database. Thus, the memory 80 of the EGD 60 may be configured to provide at least some of the data required for a player to play a game of chance, and the EGD may then obtain any other required software, data, and/or instructions from one or more other devices.

The fields of a probability database may specify, for example: (i) a random number (or range of random numbers) that may be generated by a random number generator; and (ii) an outcome that indicates the one or more indicia comprising the outcome that corresponds to the random number of a particular record. An EGD 60 may utilize a probability database to determine, for example, what outcome corresponds to a random number generated by a random number generator and to display the determined outcome. For example, the outcomes may comprise the three symbols to be displayed along the payline of a three-reel slot machine. Other arrangements of probability databases are possible. For example, the book “Winning At Slot Machines” by Jim Regan (Carol Publishing Group Edition, 1997) illustrates examples of payout and probability tables and how they may be derived. The entirety of this book is incorporated by reference herein for all purposes.

The fields of a payout database may specify, for example: (i) an outcome, which indicates the one or more indicia comprising a given outcome; and (ii) a payout that corresponds to each respective outcome. If EGD 60 comprises an electronic version of a three-reel slot machine, for example, the outcomes may mirror those obtained on a three-reel slot machine so that, after determining the outcome for displaying on the EGD display, the EGD may access a payout database to determine whether that outcome is one of the outcomes stored as corresponding to a payout. If it is, the EGD may provide the corresponding payout to the player via a benefit output device described herein. Other arrangements of payout databases are possible. For example, the book “Winning At Slot Machines” by Jim Regan (Carol Publishing Group Edition, 1997), previously incorporated by reference, illustrates many examples of payout and probability tables and how they may be derived.

The processor 62 is also operable to communicate with a random number generator 66, which may be a component of EGD 60 in some configurations or of an EGS in some embodiments, as will be described below. The random number generator 66 (as well as any other random number generator described herein), in accordance with at least one embodiment, may generate data representing random or pseudo-random values (referred to as “random numbers” herein). The random number generator may generate a random number every predetermined unit of time (e.g., every second) or in response to an initiation of a game on the gaming device. The generated random numbers may be used as they are generated and/or stored for future use.

A random number generator, as used herein, may be embodied as a processor separate from but working in cooperation with processor 62. Alternatively, a random number generator may be embodied as an algorithm, program component, or software stored in the memory of an EGD or on another device, such as on an EGS, and used to generate a random number. Alternately, an EGD owner or operator may obtain sets of random numbers that have been generated by another entity using known methods.

The processor 62 is also operable to communicate with a benefit output device 68, which may be a component of EGD 60. The benefit output device 68 may comprise one or more devices for outputting a benefit to a player of the gaming device 60. For example, in one embodiment the EGD 60 may provide coins and/or tokens as a benefit. The EGD 60 may also or alternately provide a receipt or other document on which there is printed an indication of a benefit, such as a cashless gaming receipt that has printed thereon a monetary value redeemable for cash. In such an embodiment the benefit output device 68 may comprise a printing and document dispensing mechanism, to provide, for example, a ticket, coupon, or a cashless gaming voucher having a monetary value. In yet another example, the EGD 60 may provide electronic credits as a benefit that may be subsequently converted to coins and/or tokens. In yet another example, the EGD 60 may credit a monetary amount to a financial account associated with a player, such as a credit card account, a debit account, a charge account, a checking account, and/or a casino account. In such an embodiment, the benefit output device 68 may include a credit meter balance and/or a processor that manages the amount of electronic credits that is indicated on a display of a credit meter balance. In such an embodiment the benefit output device 68 may comprise a device for communicating with a server on which the financial account is maintained.

Note that, in one or more embodiments, the EGD 60 may include more than one benefit output device 68 even though only one benefit output device is illustrated in FIG. 1B. For example, EGD 60 may include both a hopper and hopper controller combination and a credit meter balance (See FIG. 1A). Such a gaming device may be operable to provide more than one type of benefit to a player of the EGD.

The processor 62 is also operable to communicate with a display device 70, which may be a component of EGD 60. The display device 70 may comprise, for example, one or more display screens or areas for outputting information related to game play on the gaming device, such as a cathode ray tube (CRT) monitor, liquid crystal display (LCD) screen, or light emitting diode (LED) screen. In addition, the EGD 60 may include more than one display device 70, for example, an LCD display for displaying electronic reels and a viewing window behind which are located mechanical reels so that the player can view rotation of the mechanical reels during game play. The display device 70 may also be operable to display a message to a player.

The processor 62 may also be in communication with one or more other devices besides the display device 70, for outputting information (e.g., to a player or another device). Such other one or more output devices may also be components of EGD 60. Such other one or more output devices may include, for example, an audio speaker (e.g., to output a message to a player, in addition to or in lieu of such a message being output via a display device 70), an infra-red transmitter, a radio transmitter, an electric motor, a printer, a coupon or product dispenser, an infra-red port (e.g., for communicating with a second gaming device or a portable device of a player), a Braille computer monitor, and/or a coin or bill dispenser. Examples of common EGD output devices include a cathode ray tube (CRT) monitor on a video poker machine, a bell on a gaming device (e.g., rings when a player wins), an LED display of a player's credit balance, and an LCD display of a personal digital assistant (PDA) for displaying keno numbers.

The processor 62 is also in communication with an input device 72, which is a device that is capable of receiving an input (e.g., from a player or another device) and which may be a component of EGD 60. An input device may communicate with or be part of another device (e.g. a server, another EGD, etc.). Some examples of input devices include: a bar-code scanner, a magnetic stripe reader, a computer keyboard or keypad, a button (e.g., mechanical, electromechanical, or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port (e.g., for receiving communications from with a second gaming device or a another device such as a smart card or PDA of a player), and a weight scale. Common EDG input devices include a button or touch screen on an electronic video poker machine, a lever or handle connected to the EGD, a magnetic stripe reader to read a player tracking card inserted into an EGD, a touch screen for input of player selections during game play, and a coin and bill acceptor (see e.g., FIG. 1A). Input device 72 may comprise any of the above-described input devices or any combination thereof (i.e., input device 72 may comprise more than one input device).

In some embodiments, an EGD 60 may comprise components capable of facilitating both input and output functions (i.e., input/output devices). For example, a touch-sensitive display screen is an input/output device (e.g., the device outputs graphics and receives selections from players). In another example, a processor may communicate with a “ticket-in/ticket-out” device configured to dispense and receive cash-out tickets. Such a device may also assist in (e.g., provide data so as to facilitate) various accounting functions (e.g., ticket validation and redemption).

Of course, as would be understood by one of ordinary skill in the art, an EGD 60 may comprise various combinations of any or all of the component devices described herein. For example, in one or more embodiments, the EGD may include more than one display device, one or more other output devices, several input devices, and so on (e.g., two display screens, two audio speakers, a headset, a ticket-in/ticket-out device and several buttons).

The processor 62 is also in communication with a payment system 76, which may be a component of the EGD 60. The payment system 76 is a device capable of accepting payment from a player (e.g., a bet or initiation of a balance) and/or providing payment to a player (e.g., a payout). Payment is not limited to currency, but may also include other types of consideration, including products, services, and alternate currencies. Payment system 76 may be considered to be an example of an input device 72 in some embodiments.

Exemplary methods of accepting payment by the payment system 76 include (i) receiving hard currency (i.e., coin.-s or bills), and accordingly the payment system 76 may comprise a coin or bill acceptor; (ii) receiving an alternate currency (e.g., a paper cashless gaming voucher, a coupon, a non-negotiable token), and accordingly the payment system 76 may comprise a bar code reader or other sensing means; (iii) receiving a payment identifier (e.g., a credit card number, a debit card number, a player tracking card number or other account identifier) and debiting the account identified by the payment identifier; and (iv) determining that a player has performed a value-added activity.

Processor 62 may also be in communication with a player tracking device 78, which may be a component of EGD 60. Player tracking device 78 may, in some embodiments, be considered an example of an input device 72. Player tracking device 78 may, in one or more embodiments, comprise a reader device operable to read information from and/or write information to a card such as a smart card and/or a player tracking card, such that (i) players may be identified, and (ii) various data associated with players may then be determined. For example, previous wagering, coin-in and/or cash-out behaviors previously engaged in by the player, and the number of promotional credits available to that player may be determined based on information associated with the player identifier.

In one embodiment, the player tracking device 78 may comprise (i) a card reader (e.g., a port into which player tracking cards may be inserted), (ii) various input devices (e.g., a keypad, a touch-screen), (iii) various output devices (e.g., a small, full-color display screen), and/or (iv) combinations thereof (e.g., a touch-sensitive display screen that accommodates both input and output functions). Various commercially available devices may be suitable for such an application, such as the NextGen™ interactive player tracking panel manufactured by IGT or the iVIEW display screen manufactured by Bally® Gaming and Systems.

As known in the art, “smart cards” may incorporate (i) a memory, and (ii) means for accessing such a memory. For example, in one embodiment, the memory may store data related to aspects of the present invention. Data may be written to the smart card during game play, and various data may be updated on a continuous, or periodic, or event-triggered basis. Accordingly, in one or more embodiments one or more devices operable to carry out various processes of the present invention may have associated therewith a smart card reader device, such that data may be read from the smart card pursuant to the execution of such processes. In an embodiment, an “Audit Smart Card” (not shown) could be used to retrieve or download at least a portion of the audit data for a particular EGD for review. For example, such audit data may be aggregated and stored in a relational database at the EGD and then output to a memory of the “Audit Smart Card”. Alternately, the audit data may be output to another device, such as an USB Key device, or printed out at a printer for example, and then analyzed later. The audit data in the memory of the “Audit Smart Card” and/or stored on the USB Key device could be accessed, for example, by using a personal computer at another location.

In an embodiment, such an “Audit Smart Card” or USB Key device may only be issued to an authorized person, such as a casino manager or to a regulator. Such an Audit Smart Card and/or USB Key device may be configured to store the audit data in encrypted form that can only be viewed by utilizing a private key, or could otherwise be protected from unauthorized viewing or tampering by use of other appropriate security measures. In another embodiment, such an “Audit Smart Card” or USB Key device may be issued to a player and configured to make it possible for the player to access only his or her own game play audit data.

In one embodiment, EGD 60 may be operable to facilitate downloadable games such that games available for play on EGD 60 may be stored on a server device and downloaded to the EGD 60. In one embodiment, software components of the EGD 60 may be remotely modified and/or updated by another device. For example, a payout or probability table stored in the memory of EGD 60 may be altered, modified or updated remotely, hot fixes may be applied to software stored by the EGD 60 and/or new versions of software may be downloaded to the EGD 60. Similarly, the EGD 60 may be programmed to retrieve any or all such updates from another device, as appropriate. Any of the above (e.g., downloading of a game, updating of software, modification of a payout or probability table) may occur, for example, based upon an occurrence of an event (e.g., a scheduled event), an indication being received from qualified casino personnel or other personnel (e.g., a regulator), and/or upon a request from a player. In an embodiment, EGD 60 may be a thin client device that is controlled by one or more other devices.

In one or more embodiments, aspects of the present invention, such as generating an entry for an audit database, or causing an event to be dispatched in response to a request, may be practiced by replacing and/or augmenting one or more components (e.g., hardware and/or software components) of an existing EGD. Thus, in one or more embodiments, the invention may be applied as a retrofit or upgrade to existing EGDs currently available for play within various casinos.

In a specific example, a gaming device may comprise various electronic components mounted to one or more printed circuit boards (PCBs). Such components may include various hardware described herein, such as a communications port and various controllers of peripheral devices (e.g., a display controller), as well as a memory for storing programming instructions (software) and a processor for carrying out such instructions. One form of memory commonly found in gaming devices is electronically erasable programmable read-only memory or erasable programmable read-only memory (EEPROM or EPROM). Thus, in one or more embodiments of the present invention, an EEPROM storing software with instructions for carrying out aspects of the present invention (as well as instructions for carrying out other functions traditionally performed by the gaming device) may replace an EEPROM previously installed in a gaming device, such that the gaming device may be configured to operate in accordance with various processes of the present invention.

For example, an “Audit Module” may be made available for purchase to various casino operators. The audit module, which may comprise various hardware and software (e.g., an EEPROM storing software instructions), may be installed in and/or retrofit to an existing device such as an EGD (e.g., a video-reel slot machine, a video poker machine, etc.). When the Audit Module is installed (and/or retrofitted), all data concerning EGD gaming requests are tracked and stored in a memory in accordance with the methods described herein. In addition, players of the device may elect (i) to play a game offered by the gaming device and be provided with audit information that is accumulated during her game play that incorporates aspects of the present invention, or (ii) to play a game offered by the gaming device in a manner that utilizes aspects of the present invention, but that does not provide the player with a report of her gaming data. In an embodiment, the player may be charged a fee for choosing to be provided with the gaming information.

Accordingly, a gaming device may be configured to allow a player to select one of two “modes” of the gaming device, and to enable the selected mode. If a player selects a “standard game play” mode, the gaming device may be configured to operate in a manner similar to how it operated before the installation of the module (e.g., the gaming device operates in a conventional manner). If a player selects a “game play tracking” mode, the gaming device may then be operable to execute game play as before, but also operates in accordance with one or more aspects of the present invention and provides the player with her gaming information.

In one example of allowing a player to select one or more modes, a touch-sensitive display screen may be configured to output a prompt asking a player to select a mode of operation. Such a prompt may be output in occurrence to various trigger conditions (e.g., coins, bills or tickets are inserted; a credit balance increases from zero to some other number; a player presses a “play” button; a motion, weight, infrared or other sensor detects the presence of a player; etc.). Accordingly, a player may select a mode of operation (e.g., by pressing an appropriately labeled icon of a touch-sensitive display screen), and upon receiving the player's selection, the gaming device may be configured to operate in the selected mode.

In still further embodiments, rather than configure existing gaming devices to execute embodiments described herein by installing or connecting new hardware and/or software, software may be downloaded into an existing memory of one or more EGDs. U.S. Pat. No. 6,805,634 to Wells et al. teaches methods for downloading data to gaming devices in such a manner. The entirety of U.S. Pat. No. 6,805,634 is incorporated by reference herein for all purposes. Thus, in some embodiments, an existing EGD may be reprogrammed to accommodate new functionality of the present invention without the need, or by minimizing the need, to remove and replace hardware within the EGD.

Electronic Game Server (EGS) Components

FIG. 1C illustrates an embodiment of an EGS 90A configured to communicate, through a Load balance Device 86 and communications network 88, with a plurality of EGDs 10C in a system 100. The illustrated embodiment includes a second EGS 90B that is also in communication with the plurality of EGDs 10C through the Load balance Device 86 and communications network 88. It should be understood, however, that only one EGS or more than two EGS's could be used. In addition, although FIG. 1C indicates that there may be any number of EGDs (EGD-1, EGD-2 to EGD-N), in an embodiment having two EGS's as shown there will exist a threshold maximum number of EGDs 10C that could be handled to ensure that the system functions efficiently.

The EGS 90A includes a processor 91, such as one or more Intel® Pentium® processors. The processor 91 is in communication with a communication port 92 for communicating with one or more other devices, such as the Load balance Device 86, and a memory 93. The memory 93 may comprise an appropriate combination of magnetic, optical and/or semiconductor memory, and may include, for example, Random Access Memory (RAM), Read-Only Memory (ROM), a compact disc and/or a hard disk. The processor 91 and the memory 93 may each be, for example: (i) located entirely within a single computer or other device; or (ii) connected to each other by a remote communication medium, such as an Ethernet cable, telephone line or radio frequency transceiver. In one embodiment, the EGS 90A may comprise one or more devices that are connected to a separate, remote server computer or computers for maintaining databases.

The memory 93 stores a program 94 for controlling the processor 91. The processor 91 performs instructions of the program 94, and thereby operates in accordance with at least some embodiments of the present invention, and particularly in accordance with the methods described in detail herein. The program 94 may be stored in a compressed, uncompiled and/or encrypted format. The program 94 furthermore includes program elements that may be necessary, such as an operating system, a database management system and “device drivers” for allowing the processor 91 to interface with computer peripheral devices. Appropriate program elements are known to those skilled in the art, and need not be described in detail herein. The program 94 may include computer program code that allows the EGS 90A to employ the communication port 92 to communicate with one or more EGDs 10C.

According to an embodiment, the instructions of the program 94 may be read into a main memory from another computer-readable medium, such as from a ROM to a RAM. Execution of sequences of the instructions in program 94 causes processor 91 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software. For example, in an embodiment, a peripheral device may be provided for storing audit data that can only be accessed by authorized personnel, such as by a regulator and/or by a designated casino employee.

In an embodiment, the EGS 90A functions to provide one or more parameters for downloadable games playable on one or more EGDs 10C. Accordingly, as shown in FIG. 1C, the memory 93 may also store: (i) a player database 95, (ii) a gaming device database 96 that stores information related to one or more gaming devices with which the controller 90A is operable to communicate, (iii) a game database 97 that stores information regarding one or more games playable on and/or downloadable to one or more gaming devices, (iv) a scheduling and/or configuration database 98 useful for determining which games are to be made available on which gaming devices, and/or (v) an audit database 99. The player database 95 may include, for example, data corresponding to a player identifier, player preferences, an indication of wagers placed or number of games played by a player, an indication of duration of play by a player at the gaming device, and the like. The audit database 99 will be described in more detail below. Some of the information stored in the audit database may also be stored in a memory associated with or physically located at the EGD. It should be understood that the memory 93 might also store additional databases.

Similarly, in one embodiment the EGS 90A may be operable to configure one or more EGDs 10C remotely, update software stored on an EGD and/or to download software or software components to an EGD. For example, EGS 90A may be operable to apply a hot fix to software stored on an EGD 10C, modify a payout and/or probability table stored on an EGD and/or transmit a new version of software and/or a software component to an EGD. EGS 90A may be programmed to perform any or all of the above functions based on, for example, an occurrence of an event (e.g., a scheduled event), receiving an indication from a qualified casino employee and/or other person (e.g., a regulator) and/or receiving a request from a player.

Although the databases 95 through 99 are described as being stored in a memory of EGS 90A, in other embodiments some or all of these databases may be partially or wholly stored, in lieu of or in addition to being stored in a memory of controller 90A, in a memory of one or more other devices. Such one or more other devices may comprise, for example, one or more peripheral devices, one or more EGDs, a slot server (if different from the EGS 90A), another electronic gaming server (such as EGS 90B) or different type of application server, another device, or a combination thereof. Further, some or all of the data described as being stored in the memory 93 may be partially or wholly stored (in addition to or in lieu of being stored in the memory 93) in a memory of one or more other devices. Such one or more other devices may comprise, for example, one or more peripheral devices, one or more gaming devices, a slot server (if different from EGS 90A), another type of electronic gaming server or application server, another device, or a combination thereof.

For example, in an embodiment a particular EGS such as EGS 90A may be designated an “Audit Server” and function to obtain and store EGD gaming requests, responses, outcomes and/or other data that concern an EGD 10C, or a group of EGDs, or an entire system of EGDs. In an embodiment, the Audit Server may be operable to obtain and store audit data of a group of EGDs, for example, that are all in one physical location, such as a gaming floor of a casino, or in a lounge area of a hotel or restaurant, or in an airport lounge. In other implementations, one or more Audit Servers may function to obtain and store audit data of EGDs in disparate locations that may be owned by different entities. It is also contemplated that one or more Audit Servers may function to automatically analyze a portion or portions of the audit data concerning any particular EGD or group of EGDs (as described in more detail below). In addition, each Audit Server may be a secure computer that can only be accessed by a regulator, or authorized casino personnel, or other authorized person. Accordingly, to access the audit database, the Audit Server may require input of security codes, such as one or more passwords, and may also utilize additional security measures such as firewall programs to prevent unauthorized persons from viewing and/or modifying the data gathered therein.

In some embodiments, an EGS may be a Web Server, and the EGD may be a device such as a standard casino gaming machine such as a reeled slot machine, a computer with a web browser, a cell phone with application software, an internet ready PDA, and the like. Accordingly, it should be noted that in some embodiments the EGS may be configured to communicate with an audit database, but the EGD or EGDs may not have that functionality. For example, a cell phone having gaming application software may communicate with a web server but not be able to communicate with an audit database.

System Configurations

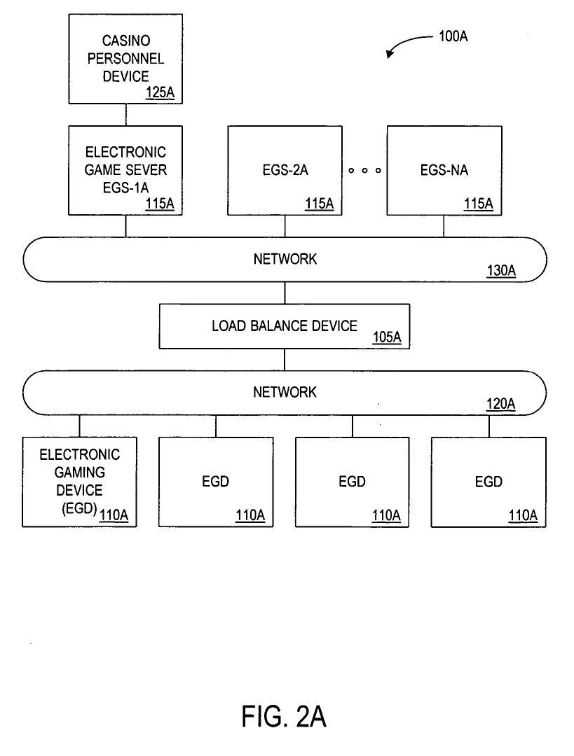

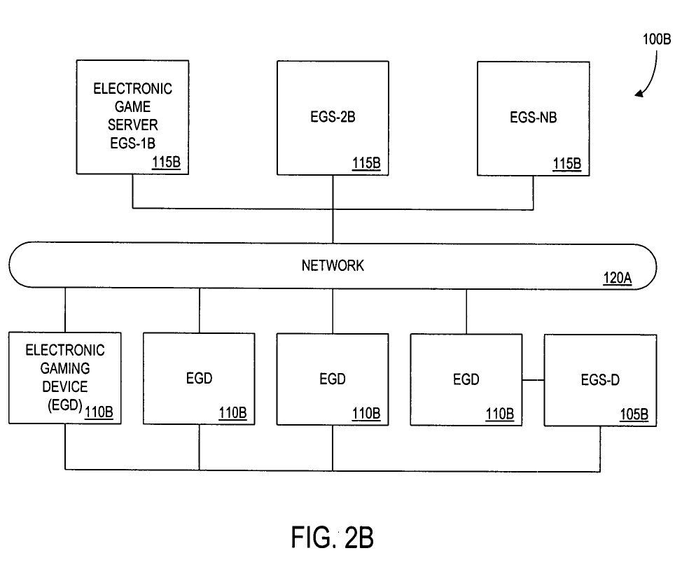

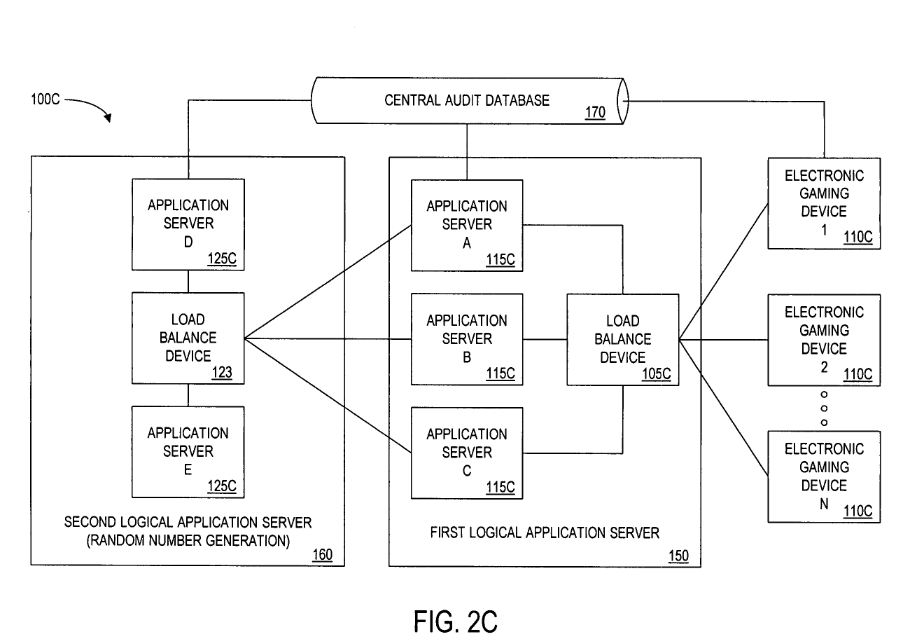

FIGS. 2A to 2C illustrate exemplary embodiments of system architectures that may be utilized. It should be understood that other system architectures could also be utilized, and thus FIGS. 2A to 2C do not limit the apparatus, methods and/or processes disclosed herein.

FIG. 2A is an example embodiment in block diagram form of a system 100A that may be utilized in accordance with the invention. Embodiment 100A is referred to as system 100A herein. Embodiments described herein can be configured to work as a system 100A in a network environment including a plurality of Electronic Game Servers (EGS's) 115A in communication, through a communications network 130A, with a Load balance Device 105A that is also in communication, via a communications network 120A, with one or more Electronic Gaming Devices (EGDs) 110A (e.g., slot machines, video poker machines, and the like as described above with reference to FIGS. 1A and 1B). One or more of the EGS's 115A may also be in communication with one or more casino personnel devices 125A.

In FIG. 2A, the Load balance Device 105A may be in communication with any and all of the gaming devices 110A through network 120A directly or indirectly, via a wired or wireless medium such as the Internet, LAN, WAN or Ethernet, Token Ring, or via any appropriate communications means or combination of communications means. The Load balance Device 105A may comprise a hardware device such as the “Content Switching Module” included in some products manufactured by the Cisco Systems Company, or may be implemented by software that may be located in another device or devices, such as the “Network Load Balancing” software developed by the Microsoft Company. The Load balancing Device 105A operates to route EGD 110A requests through communications network 130A to an appropriate one or more of the EGS's 115A. For example, a gaming request from a particular EGD 110 may be routed to EGS-1A because it is the least busy of any of the EGS's 115A at that time, or because all such requests from that particular EGD are routed to EGS-1A at least initially, or because another criteria was satisfied to cause the request to be made to EGS-1A. It should be understood that many different variables and/or factors and/or criteria may be considered to determine which particular EGS or group of EGS's should be used to use to handle an EGD request.

Each of the EGD's 110A may comprise computers, such as those based on the Intel® Pentium® processor, or alternatively based on dedicated computing hardware, that are adapted to communicate with the Load balance device 105A. Any number, type and/or number of types of EGD's 110A may be in communication with the Load balance Device 105A.

The Load balance Device 105A may also be in communication with one or more EGS's 115A, labeled EGS-1A, EGS-2A to EGS-NA through a second communications network 130A, as shown. The second network 130A may include firewall software to screen all requests from the Load balance Device 105A to prevent, for example, unauthorized software from infecting, modifying or otherwise damaging any of the data or software residing in the EGS's 115A. Each of the EGS's 115A may be responsible for performing one or more particular gaming functions, and may communicate gaming results or other data or information to one or more of the EGDs 110A, which will be explained in more detail below. It should be noted that communications network 130A may be substantially the same network as communications network 120A or it may be differentiated by subnet division and the like.

Communication between the EGDs 110A, the Load balance Device 105A, the plurality of EGS's 115A, and/or the casino personnel devices 125A, may be direct or indirect, such as over the Internet through a LAN (Local Area Network), WAN (Wide Area Network), or over an on-line data network including commercial on-line service providers and the like. In yet other embodiments, the EGD's 110A may communicate with one another and/or the Load balance Device 105A, and the plurality of EGS's 115A may communicate with the Load balance Device 105A, over RF, cable TV, satellite links and the like.

Some, but not all, possible communication networks that may comprise the network 120A and/or network 130A or be otherwise part of the system 100A include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Wi-Fi, Bluetooth™, and TCP/IP. Communication may be encrypted to ensure privacy and prevent fraud in any of a variety of ways well known in the art.

A variety of communications protocols may be part of the system 100A or another system operable to facilitate the embodiments described herein, including but not limited to: Ethernet (or IEEE 802.3), SAP, SAS™, SuperSAS™, ATP, Wi-Fi, Bluetooth™, USB, and TCP/IP. Further, in some embodiments, various communications protocols endorsed by the Gaming Standards Association of Fremont, Calif., may be utilized, such as (i) the Gaming Device Standard (GDS), which may facilitate communication between a gaming device and various component devices and/or peripheral devices (e.g., printers, bill acceptors, etc.), (ii) the Best of Breed (BOB) standard, which may facilitate communication between one or more EGDs and various EGS's related to play of one or more EGDs (for example, the EGS's may be configured to assist in providing accounting data, player tracking data, content management data, ticket-in/ticket-out data and progressive jackpot functionality), and/or (iii) the System-to-System (S2S) standard, which may facilitate communication between game-related servers (EGS's) and/or casino property management servers (for example, a hotel server). Communication may be encrypted or otherwise made secure to ensure privacy and prevent fraud in any of a variety of ways well known in the art.

In some embodiments, the Load balance Device 105A and/or the plurality of EGS's 115A may not be necessary and/or preferred. For example, in one or more embodiments, each EGD 110A may be configured to communicate with a particular EGS 115A abrogating the need for a Load balance Device. In other embodiments, each EGD 110A may be configured to communicate with a group of EGS's 115A in a predetermined manner so that a load balancing device would not be required.

In another embodiment, a particular EGD 110A may be in communication with one or more other EGDs 110A (i.e. without a Load balance Device 105A or the EGS's 115A). In such embodiments, any functions described as performed by the Load balance Device 105A or EGS's 115A, or data described as stored on any of the EGS's 115A, may instead be performed by or stored on one or more EGDs 110A. Such a configuration may be used, for example, where a small number of EGDs (for example, a system having five or less EGDs) are deployed by a casino or other organization, and one or more of the EGDs may be configured to double as EGS's.

In one or more embodiments, system 100A may include additional devices, such as one or more additional Load balance Devices, one or more additional groups of EGS's, and/or one or more additional application servers (e.g., a hotel reservation server, a problem gambler management server, and/or an inventory management server). Such additional devices may store additional information, and such information may also be stored at one or more of the EGS's 115A, and/or in one or more of the EGDs 110A, and/or in other devices. In such embodiments, the system 100A may or may not be a closed network, which may depend upon, for example, the level of security required of the system.

In some embodiments, various casino employees may be equipped with, or otherwise utilize, one or more casino personnel devices 125A. Casino personnel devices may include personal digital assistants (PDAs) or other computing devices (e.g., a laptop computer or other personal computer terminal). A casino personnel device 125A may comprise, for example, one or more of various input devices (e.g., a keypad, a touch-sensitive display screen, a card reader, an infrared bar code scanner, etc.), various output devices (e.g., an LCD screen), a processor, and/or a memory and/or a communications port. In some embodiments, as shown in FIG. 2A, a casino personnel device 125A may be configured to communicate with one or more EGS's 115A. In other embodiments, the casino personnel device 125A may be configured to communicate with one or more EGDs, other types of servers, a kiosk, a peripheral device, and/or an inventory/reservation system of a casino-maintained property (e.g., a hotel). Thus, a casino personnel device may be configured to, among other things, read from and/or write to one or more databases, and/or execute or assist in the execution of various other processes described herein. In one or more embodiments, a casino personnel device may be operable to read data from and/or write data to one or more of the databases described herein. A memory of a casino personnel device may store a program for executing processes described herein, or portions thereof.

In some embodiments, one or more of the EGS's 115A may be operable to communicate with one or more servers of a casino other than the casino associated with the system 100A, in order, for example to share information regarding casino security. In yet other embodiments, one or more of the EGS's 115A may be operable and/or configured to communicate particular data to a logically distinct server or servers that may be controlled by, or otherwise restricted for use by, a casino regulator or other designated entity.

In some embodiments, various component devices (e.g., any or all of the benefit output devices, output devices, input devices and/or input output devices described herein) may be embodied as peripheral devices. For example, such devices may not necessarily be components of an EGD, though they may be configured in such a manner so as to communicate with one or more EGD processors or any other devices described herein. For example, a peripheral device such as a storage device may be associated with a plurality of EGDs, and thus may not necessarily be considered a component of any one EGD. In other embodiments, various peripheral devices may never be considered a component of a particular EGD. For example, in some embodiments, a peripheral device such as an USB-based portable memory device such as an USB-key storage device may store (i) one or more databases described herein, and/or (ii) a program for executing one or more process steps described herein. Such a peripheral device may then be utilized by casino personnel, for example, for upgrading, retrofitting and/or for obtaining audit data for one or more EGDs as described herein.

It should be understood that one or more of the EGS's 115A might be implemented as a system controller, a dedicated hardware circuit, an appropriately programmed general-purpose computer, or any other equivalent electronic, mechanical or electromechanical device, for example a UNIX-based or LINUX-based device. An EGS may be operative to execute some or all of the methods described herein, and in operation, may function under the control of a casino, or other entity such as a regulator that may also control or regulate the use of the EGDs 110A. For example, an EGS 115A such as EGS-2A may be a slot server in a casino, whereas in other embodiments the EGS-2A may be distinct and different from a slot server.

FIG. 2B is an example embodiment in block diagram form of another system 100B that may be utilized in accordance with the invention. Embodiment 100B is referred to as system 100B herein. Embodiments encompassed by the present description can be configured to work as a system 100B in a network environment including a plurality of EGS's 115B in communication, through a communications network 120B, with a plurality of EGDs 110B (e.g., slot machines, video poker machines, and the like). The configuration of system 100B differs from the system 100A of FIG. 2A in that an EGS 105B (EGS-D) is configured as a director device and is configured for communications with each EGD 110B. The components of the EGDs 110B, EGS's 115B and communications network 120 may be the same as, or similar to the components of the EGDs 110A, EGS's 115A and communications network 120A of FIG. 2A, and thus details of their descriptions will not be repeated here.

EGS-D 105B is configured as a director device, and is operable to receive gaming requests from each of the EGDs 110B and to respond by directing a particular EGD to transmit its request to a particular EGS or group of EGS's. In this manner, EGS-D 105B handles the load balancing duties for the system 100B. For example, EGS-D 105B may direct a particular EGD to transmit a gaming request to EGS-2B because it is the least busy of any of the EGS's 115B at that time, or because EGS-D determined that the EGS-2B satisfied some other criteria that was used to determine where that request should be directed. It should be understood that many different variables and/or factors and/or criteria may be considered by the EGS-D 105B to determine which particular EGS or group of EGS's to use to handle an EGD request. For example, the EGS-D may be configured as a DNS server running software such as the DNS Round Robin algorithm to handle EGD gaming requests.

It should be understood that one or more of the EGS's 115B and/or of the EGDs 110B or the EGS-D might also be in communication with other devices. For example, one or more casino personnel devices and/or peripheral devices may be configured to communicate with one or more of the EGS's 115B or the EGS-D. Details concerning such devices have already been described above, and thus will not be repeated here.

Communication between the EGDs 110B, the EGS-D 105B and the plurality of EGS's 115B, may be direct or indirect, such as over the Internet through a LAN (Local Area Network), WAN (Wide Area Network), or over an on-line data network including commercial on-line service providers and the like. In yet other embodiments, the EGDs 110B may communicate with one another and/or the EGS-D 105B, and the plurality of EGS's 115B may communicate with the EGDs 110B, over RF, cable TV, satellite links and the like.

In some embodiments, the EGS-D 105B may not be required and thus may be omitted. For example, in a system 100B having a relatively small number of EGDs, each EGD or groups of EGDs could be configured to make gaming requests to a particular EGS 115B through the network 120B. For example, groups of five EGDs may be programmed to transmit requests to EGS-1B, another group of five EGDs programmed to transmit requests to EGS-2B, and so on. Other protocols for directing EGD requests to particular EGS's could also be used, for example, depending on the function or functions performed by one or more EGS's. For example, all requests for generating random numbers could be handled by a first EGS, all poker gaming requests for mapping random numbers to cards for a video poker device could be handled by a second EGS, and all requests for mapping random numbers to slot icons for video reel slot devices could be handled by a third EGS. In other embodiments, two or more EGS's may function to generate random numbers, for example, or perform other functions. In addition, the two or more EGS's may be operable to communicate with each other to coordinate processing to satisfy EGD gaming requests.

FIG. 2C is a simplified schematic block diagram illustrating the architecture of another system 100C according to the invention. The network 100C includes a plurality of Electronic Gaming Devices 110C, a first Logical Application Server 150 that includes a load balancing device 105C in communication with a plurality of application servers or EGS's 115C, a second Logical Application Server 160 having another load balancing device 123 in communication with another plurality of application servers or EGS's 125C, and a Central Audit Database 170. A “Logical Application Server” may be defined as two or more application servers or EGS's with equivalent functionality, any of which could satisfy a gaming request from an EGD. The Load balance Devices 105C and 123 may comprise a hardware device such as the “Catalyst” device with a “Content Switching Module” included in some products manufactured by the Cisco Systems Company, or may be implemented by software that may be located in another device or devices (such as one or more of the EGS's 115C or 125C), such as the “Network Load Balancing” software developed by the Microsoft Company.

Referring again to FIG. 2C, shown for ease of understanding are communication paths between the Central Audit Database 170 and Electronic Gaming Device 1 110C, between the Central Audit Database and the Application Server A 115C, and between the Central Audit Database and the Application Server D 125C. But it should be understood that, in some embodiments, the Central Audit Database may be in communication with any or all of the EGS's 115C, and/or with any and all of the EGS's 125C, and/or with any or all of the EGDs 110C. In addition, the Central Audit Database 170 may be configured to communicate with various peripheral devices.

The network 100C might include more or less EGDs 110C, more or less Logical Application Servers 150 and 160, and more or less application servers 115C and/or 125C within the Logical Application Server layers. Accordingly, there may be additional Logical Application Server layers which may depend upon, for example, the number of EGDs in a system, and/or the types and numbers of functions that the EGS's are required to perform to satisfy EGD requests.

Communication between the EGDs 110C, the Load balance Device 105C, the plurality of EGS's 115C, the Load balance Device 123, the EGS's 125C and the Central Audit Database 170 may be direct or indirect, such as over the Internet through a LAN (Local Area Network), WAN (Wide Area Network), or over an on-line data network including commercial on-line service providers and the like. In yet other embodiments, the EGDs 110C may communicate with one another and/or the Central Audit Database 170 and/or the Load balance Device 105C, over RF, cable TV, satellite links and the like. Similarly, the Load Balance Device 105C, the EGS's 115C, the Load balance Device 123, the EGS's 125C and the Central Audit Database may communicate over RF, cable TV, satellite links and the like.

In an alternate implementation of the network 100C, one or both of the Load balance Devices 105C and 123 may not be necessary or required. This may occur, for example, in a configuration having only one or two application servers (EGS's) 115C servicing the EGDs. In such a case, each of the EGDs 110C may be configured to contact a particular one of the EGS's 115C first, such as Application Server A, and then that EGS would either process the gaming request or route it to another EGS 115C for processing. In another embodiment, each EGD of a group of EGDs may be programmed to communicate only with a particular Application Server 115C of the First Logical Application Server 150 which handles game requests for that group. It will be apparent to one skilled in the art that other schemes or protocols could be used in such a system to process EGD requests in an efficient and timely manner.

The Central Audit Database 170, which in an embodiment manages information for transactions from the plurality of EGDs, may not be required in some implementations. For example, when a small number of EGDs, such as 25 EGDs or less, are utilized then an audit database that stores only audit data for the device on which it resides may exist. Such an audit database may reside, for example, in one or more of the Application Servers of either the First Logical Application Server 150 or the Second Logical Application Server 160. In some embodiments, one or more of the EGDs 110C might store an audit database for the system. In some embodiments, portions of the audit database may be stored in any of a plurality of the devices associated with the system 100C. Accordingly, in some embodiments the central audit database concept may be realized by shared hardware instead of by using dedicated hardware.

When a large number of EGDs are deployed (for example, 500 or more video poker terminals on the gaming floor of a casino), the Logical Application Server 150 may be implemented by using two or more physical EGS's as shown in FIG. 2C. The Load-balancing Device 105C is used to distribute calls or requests to a particular IP address, or other machine identifier, to one of a plurality of physical computers (i.e. one or more of the EGS's 115C), each having the same software. The particular EGD that made the request may not be informed of whether the request is satisfied by one computer with the IP address (or other machine identifier) to which the request was made (for example, Application Server A of FIG. 2C), or whether this request was satisfied by a computer with a different IP address (i.e. Application Server C), or whether this request was satisfied by several computers. In another embodiment, the device corresponding to the original IP address, for example Application Server B in FIG. 2C, may redirect the EGD to repeat the request to another one of a plurality of IP addresses corresponding to another of the EGS's 115C. In another embodiment, a particular EGS may act as a controller or director device for routing EGD requests (such as the EGS-D 105B of FIG. 2B), and such a configuration may be implemented in software, for example, in network drivers.

System Operation

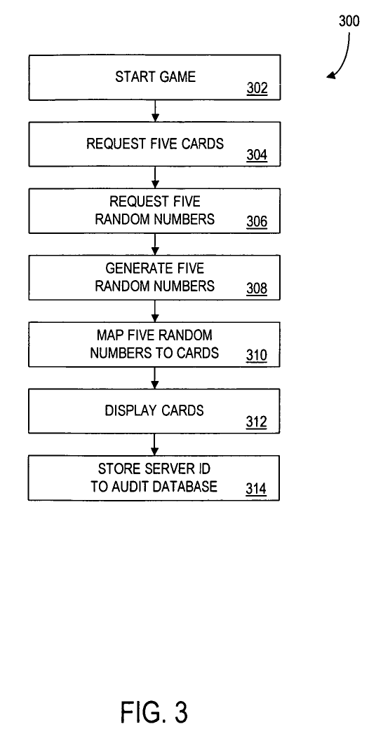

FIG. 3 is a flowchart illustrating an embodiment of the operation of an electronic device, such as an EGD, in a gaming system such as systems 100A to 100C described above. In a thin-client architecture, a player initiates game play (302) at a particular EGD, which may be, for example, a video poker machine. In step 304, the EGD that is being utilized by the player makes a request for five cards to be generated by some other device (for example, the EGD is a video five card stud gaming machine and cannot itself generate the information). A request parameter is five-card stud, which entails requesting five random numbers in step 306. In step 308, five random numbers are generated, which may be handled by an EGS in a group of EGS's, for example Application Server D of the second Logical Application Server 160 shown in FIG. 2C, or by a random number generator, or by a designated EGS having that functionality. Typically, this request is made through a software interface (i.e. an application programming interface or API). Next, in step 310, the five random numbers are mapped to cards, which function may be handled by an EGS or Logical EGS (such as first Logical Application Server 150 of FIG. 2C) that is different from, or the same as, the EGS or Logical EGS that generated the random numbers. The results are transmitted back to the requesting EGD, which then uses the information in step 312 to display the cards on a video screen to the player. In addition, transaction data that includes a server ID is stored in step 314 to an Audit Database. The server ID identifies which physical machine or machines (an EGS or group of EGS's) that were responsible for satisfying the game request from the EGD. Of course, in other embodiments requests may be made for random numbers corresponding to other types of five card sets, or for more or less random numbers depending on the game being played. For example, three random numbers may be requested for a three-reel slot machine, or seven random numbers may be solicited for a seven-card stud machine.

The response of an EGS or other device to the request of an EGD includes audit data having audit trail information. For example, the application programming interface (API) that defines the functionality made available by an EGS to an EGD may include the audit information in the response. The EGD may store this information, for example, in a persistent or non-volatile memory. Each EGD may store audit trail information concerning itself only, or one or more particular EGDs may store audit trail information for a plurality of EGDs. Such audit trail information may be assembled such that the data for particular groups of EGDs are stored together.

Gaming request audit data may include data indicative of the type of gaming request made by an EGD, data indicating the device or devices that responded to at least a portion of the request, data indicative of devices that routed at least a portion of a request to other devices, data indicating at least a portion of the response that that satisfied at least a portion of the gaming request, and the like. For example, gaming request audit data that may be stored in a memory could include an EGD identifier, at least one EGS identifier corresponding to at least one responsive EGS (wherein a responsive EGS is one that supplied at least a portion of the gaming data to the EGD), the time (which may be in the format, for example, of hours, minutes, seconds and date) of the gaming request and/or a transaction identifier. The gaming request audit data could also include such data items as an indication of the gaming request (i.e. generate random numbers and deal five cards), request parameters (i.e. five random numbers and five card stud), response parameters (the five random numbers and a mapping to five cards), an indication of at least one function performed by the EGD (which may, for example, generate random numbers), a software version identifier indicating the level of software utilized by at least one responsive EGS and/or software that is running on the EGD, an encrypted cryptographic hash of at least one data item associated with the gaming request audit data, and a processing time corresponding to the period of time utilized to process the gaming request.

In an embodiment, the audit data is stored in a database on each physical EGS and/or EGD. In such embodiments, the audit data also includes information identifying the audit record with a specific EGD request. The audit information may also include information to identify the EGD. In some of these embodiments, this additional information may include the EGD's request identifier, such as a transaction ID. In other embodiments, the information may include the time of the request, which may allow the identification of the audit record with a specific EGD request. The audit information may include information about the requesting machine, whether EGD or EGS (for example, in a cascaded request initiated by an EGD). In some embodiments, further information such as a player identifier may be included.

In other embodiments, the audit information is stored on Logical Servers not involved in the functional response to the EGD request. For example, a Logical Server may be deployed alongside the same physical hardware as a system that includes the EGD and the EGS's that provide the functions requested by the EGD. In some embodiments, the EGD receives all of the audit information and then transmits the information to an Audit Server for storage. In other embodiments, each physical EGS transmits its audit information to the Audit Server. In some embodiments, each EGS and each EGD transmits audit information to the Audit Server. The Audit Server maintains a memory of the records in the audit trail, for example, in a persistent memory. In some of these embodiments, the audit trail data is saved in the memory as a searchable database to facilitate the analysis of the information.

In embodiments where the audit information is stored on the EGD, when a request is made to analyze the audit data, the analysis process may consist of requesting all audit information related to a specific EGD request (or plurality of requests of that EGD, or all requests that occurred in a specific time frame, for example). Where the audit information is stored on each physical EGS, the analysis process may include contacting each EGS and requesting audit records related to a specific EGD request. For example, transaction ID data and/or EGD identifier data may be broadcast to each EGS in the system, or EGD identifier data and the time of the request may be broadcast to each EGS in the system, and then all response data aggregated to provide the information. In an embodiment, the audit data that is provided may be assembled and saved in a searchable database. In this manner, the audit records related to a specific request can be gathered from the various EGS's that responded to that EGD request.

In embodiments where the audit information is stored on an Audit Server or Central Audit Database, the analysis process includes contacting the Audit Server or Central Audit Database and requesting the audit data related to a specific EGD request. This can be accomplished, for example, by using the transaction ID and/or EGD identifier, and/or by using an EGD identifier and the time frame of the request. In this manner, a search can be made of the database stored on the Audit Server or of the Central Audit Database to easily obtain the audit records related to a specific request.

It should be noted that, in a gaming system configuration such as system 100C described above, when a particular EGD such as Electronic Gaming Device 2 makes a gaming request, it is unknown exactly which EGS in which layer or layers of Logical Application Servers (i.e. which EGS 115 in the first Logical Application Server layer 150 and/or which EGS 125 of the Second Logical Application Server layer 160) will satisfy that particular request. Consequently, in an embodiment the audit data associated with each request is obtained and saved in the memory of one or more of the EGS's of either or both of the First and Second Logical Application Servers 150 and 160. The audit data may then be transmitted to the Central Audit Database 170 according to various protocols, which are described below.

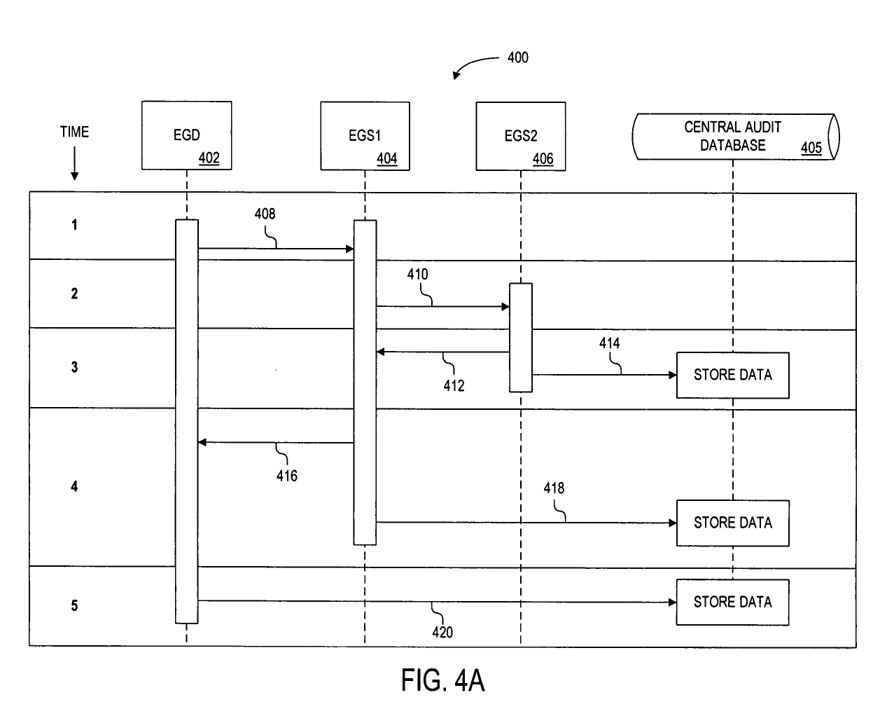

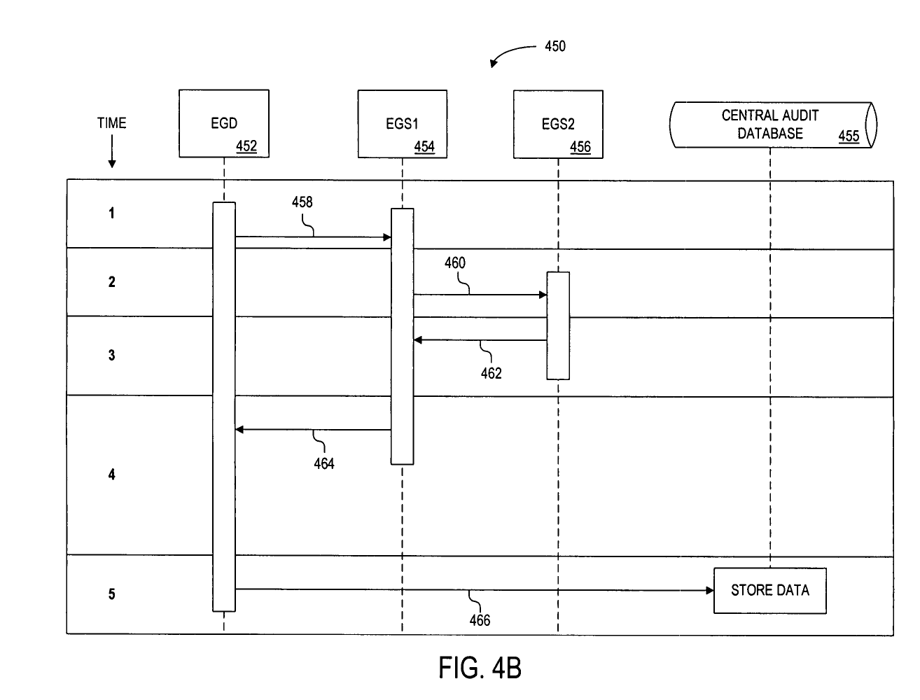

FIG. 4A is a sequence diagram 400 illustrating an embodiment in which the Central Audit Database 170 of FIG. 2C is updated continuously and/or substantially simultaneously in real time as EGD requests are being processed and results are being transmitted. Referring to FIG. 4A, the ordinate indicates the passage of time increments as events occur during processing of an EGD request. The request is transmitted, in this example, from an EGD 402 to an EGS1 404, then to EGS2 406, and responses are transmitted back to EGS1 404 and finally to the EGD 402. In addition, a Central Audit Database 405 is updated with audit data as explained below, In this example, two different physical EGS's, the EGS1 404 and the EGS2 406 work together to satisfy a gaming request from an EGD 402. In this case, the EGD 402 is a video poker machine, and a request for five cards 408 is made at time 1. EGS1 receives the request and transmits a request for five random numbers 410 at time 2 to EGS2. The EGS2 generates and transmits the five random numbers at time 3, and at the same time transmits audit data 414 to the Central Audit Database 405 for storage therein. Next, the EGS1 maps the five random numbers to cards and transmits the five cards 416 at time 4 to the EGD, and at the same time transmits audit data 418 to the Central Audit Database 405 for storage. The EGD displays the poker hand to the player and transmits audit data 420 at time 5 to the Central Audit Database. Accordingly, in system 100C for example, each active Application Server 115C of the First Logical Application Server 150 and/or each active Application Server 125C of the Second Logical Application Server 160, and/or each active EGD 110C transmits audit data to the Central Audit Database 170 as processing of EGD requests are occurring. In another embodiment, one or more of the Application Servers 115C and/or Application Servers 125C, and/or EGDs 110C may acquire and store the audit data locally (i.e. to memory that is physically located at the particular EGS or EGD).

FIG. 4B is a sequence diagram 450 illustrating another embodiment of a process for providing audit data to the Central Audit Database. Again, the EGD 452 is a video poker device and requests gaming data that is satisfied by two different physical EGS's, EGS1 454 and EGS2 456. The EGD 452 requests five cards 458 at time 1. EGS1 receives the request and transmits a request for five random numbers 460 at time 2 to EGS2. The EGS2 generates and transmits the five random numbers 462 at time 3. In addition, EGS2 may include identification in its response. Next, the EGS1 maps the five random numbers to cards and transmits the five cards 464 at time 4 to the EGD. The EGS1 may also include identification information it its response, in addition to the identification information provided by the EGS2. The EGD displays the poker hand to the player and transmits audit data 466 at time 5 to the Central Audit Database. Thus, an active EGD 110C of a system 100C, for example, may keep track of every request and response associated with itself during processing, and then transmit such audit data to the Central Audit Database 170 as gaming requests are satisfied. Such operation would cut down on the number of logging events at the Central Audit Database as compared to the process described above concerning FIG. 4A. A potential drawback of using the process illustrated by FIG. 4B is that, if one or more of the processing steps fails before completion of the response to a request, sometime before step 464, then the EGD 452 will not have any record of which physical EGS or EGS's handled a particular request. Thus, a hardware or software failure that physically occurred, for example, at EGS1 or EGS2 may be impossible or difficult to trace, especially if the system includes multiple logical server layers.

The process of FIG. 4B may be preferred in some system embodiments because each EGD stores requests and obtains data concerning the identity of the EGS or EGS's that satisfied the requests and may store the same in a local memory. Alternately, each device of interest in the network 100C (i.e. all Application Servers and EGDs) could store audit data associated with itself in a local memory. In other embodiments, one or more of the Application Servers 115C and/or Application Servers 125C, and/or EGDs 110C may contain an audit database and acquire and store the audit data for all of the other devices in the system.

Other methods of storing audit data could be used. For example, audit data may be transmitted to the Central Audit Database 170 only at periodic intervals from local storage of an EGD or group of EGDs. In an implementation, the Central Audit Database may be updated several times (e.g. four times) per day by all of the EGDs at certain preset times. In another embodiment, the Central Audit Database may be updated more or less frequently at particular times of the day when EGD activity is detected as being low, or could be updated only once per day. For example, Extraction Transformation Loading (ETL) of audit data from each of the Application Servers 115C and 125C could occur once each day at 3:00 AM when it is likely that EGD activity is low. For large installations of EGDs (for example, 500 or more electronic gaming machines connected together in the same network), ETL processing could detrimentally affect the response time of some of the EGDs if a majority of the EGDs in the network are in use during the processing. For this reason, processing the audit data for the entire network of EGDs and storing the audit data in the Central Audit Database should occur when most of those EGDs in the network are idle. Such a situation could be automatically detected in order to initiate ETL processing, for example, the system could be monitored at certain times of the day when a threshold percentage or portion of the EGDs would be expected to be idle. If the number of EGDs in operation is less than the threshold value then ETL processing occurs.

In an embodiment of a thin client gaming system that contains a large number of EGDs, for example 500 or more, tracking and storing all EGD requests simultaneously (i.e. as they are occurring during game play) may cause performance problems. For example, one or more players may experience sluggish results or responses from the EGD being played, which may lead a player to believe that the EGD is defective resulting in the player stopping the use of that EGD to gamble. Thus, different modes of operation could be available in a system so that a “full audit mode”, wherein all EGD requests are tracked simultaneously as processing of requests and responses occur in the system, would not be used, or would be used sparingly. A “standard tracking mode”, wherein a predetermined limited amount of the request and response parameters are tracked and/or stored, may be used instead. For example, the standard tracking mode may provide for auditing subsets of the EGDs in a system on a rotating basis. In a particular exemplary implementation for a network including several hundred EGDs, the EGDs could be divided into groups of twelve, and each EGD in a group could be monitored for a different five-minute interval per hour to generate audit data during the intervals. The audit data corresponding to that activity could then be stored in the Central Audit Database 170, which would drastically reduce the level of logging activity in comparison to using a full audit mode of operation. Accordingly, such a standard mode of operation provides audit data that is a five minute snapshot per hour for each EGD in the network which may be useful to spot check any particular EGD. Another “limited tracking mode” could be defined as well, which may correspond to one of the 30 methods already described above that limits the amount of EGD requests that are tracked and stored so that system performance is not degraded. Thus, it should be understood that one skilled in the art could utilize other time periods of longer or shorter duration to monitor and generate the audit data for one or more EGDs.

In another embodiment, full audit mode may be implemented continuously to track the audit data for only some of the EGDs in the network, for example, for those EGDs that are situated close to an exit of the casino, or for those EGDs that have a history of fraud attempts, or for high level “coin in” or “progressive” EGDs that take in a large amount of coinage from players. In yet another embodiment, a standard tracking mode could be used most of the time, and then a full audit mode is implemented only during low activity points during a typical weekday or weekend. In another implementation, full audit mode may only 10 be implemented when an event is detected in the system that is typically associated with a malicious attack or that has been identified as being associated with another type of anomaly. In yet another embodiment, full audit mode may be implemented on a rotating basis among different groups of EGDs depending on, for example, their physical location on the casino floor, or the time of day, or a preliminary indication of an error, or on some combination of these or other items or events.

In another embodiment, an EGD may be operable to automatically determine whether it should switch modes from a standard mode to another mode. A particular EGD may perform such a determination, for example, by evaluating data received from a player and/or from another device and/or by querying another device. For example, referring to FIG. 2C, an EGD such as Gaming Device 4 may be programmed to interrupt play when a particular type of response to a request occurs that may be associated with a particular type of anomaly. Such a response may be transmitted to the EGD from another device such as an EGS. For example, a winning combination has been displayed by the EGD to a player based on data received from an EGS, but the expected instructions to execute a payout were not received. In another example, a full audit mode may be triggered if a non-winning combination was displayed to a player but the EGD paid out a jackpot amount.

In an embodiment, an EGD may be operable to output an indication that it is currently in a “trouble-shooting” mode (e.g., to inform a player that the EGD has been taken out of service). A trouble-shooting mode may be entered when a serious type of anomaly occurs, such as the failure of an EGD to perform one or more critical gaming functions that might be due to a hardware or software failure. This may be the highest level of protection for an EGD, and may also cause a full audit mode to be entered for that EGD. In such a case, the gaming device may turn on a light, change graphics, output a sound, and the like.

Accordingly, the audit data may be used to determine which devices were involved in computing parameters and presenting a particular result for a request that occurred at a particular time because an anomaly also occurred. In addition, the audit trail could be used to determine which devices computed which portions of a response to a request that may have been responsible for an anomaly occurring at a particular EGD. For example, if the reels of a video slot machine, such as Gaming Device 3, displayed a combination that was a loser, but Gaming Device 3 provided a payout to the player, the audit data could be used to determine which Applications Server or Servers computed the response parameters for that game play.

In another example, casino personnel could use the audit data to determine if a complaint made by a player about game play at an EDG is genuine. For example, a player may assert that a winning combination for a jackpot occurred while he was playing Gaming Device 4 at 9:35 PM on Saturday night, but that he was not paid a jackpot (i.e. the player asserts that a cherry, cherry, cherry combination appeared on a payline of the EGD he was playing but no jackpot was given). Casino personnel could access the audit trail for Gaming Device 4 at that time and check to see which EGS or EGS's processed the request, what response parameters were generated, and what result was displayed on the screen of the Gaming Device 4. If no discrepancy appeared in the responses, the game results that were displayed and/or the payout (if any), then the player could be informed that the Gaming Device 4, and the game processing that occurred in the system were checked, and that no error occurred. Alternately, if it is found that the player is correct, then the casino employee could pay the player the jackpot amount and have Gaming Device 4 and any EGS's that were involved checked for any hardware or software problems.

Audit Database

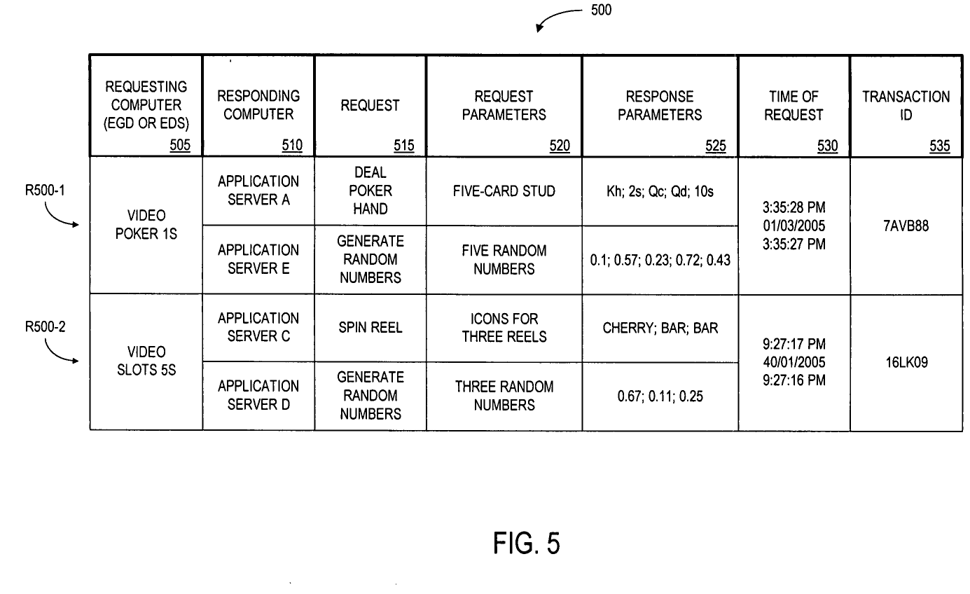

FIG. 5 is a tabular representation of an example embodiment 500 of an audit database 170. The embodiment 500 is referred to as an audit database 500 herein. The audit database 500 may reside in the memory of a device (e.g., a memory in one of the EGS's, in a memory of one or more Application Servers, or in a memory of any one EGD or combination of EGDs, or in a Central Audit Database). In addition, the audit database 500 may be stored in tabular form, or any other appropriate database form, as is well known in the art. For example, the audit data could be stored in relational databases, or could be stored in a database containing flat-files. In addition, an object-based model could be used to store and manipulate the data types of the present invention and likewise, object methods or behaviors can be used to implement the processes of the present invention.

The gaming request audit data stored in the audit database may include a number of exemplary records or entries, including records R500-1 and R500-2, each defining gaming information about a particular EGD or EGS. The specific data and fields illustrated in FIG. 5 represent only some embodiments of the records stored in the databases described herein. The data and fields of these databases can be readily modified, for example, to include more or fewer data fields, and the number and content of the entries can be different from those illustrated herein. Thus, those skilled in the art understand that the schematic illustrations and accompanying descriptions of the fields of the sample Audit Database 500 shown in FIG. 5 are exemplary arrangements for stored representations of information. It should be noted that in the Audit Database 500, a different reference numeral is employed to identify each field of gaming request audit data. However, in at least one embodiment, fields that are similarly named (e.g., request and request parameters fields) may store similar or the same data in a similar or in the same data format.

Referring now to FIG. 5, the Audit Database 500 may also define fields for each of the entries or records. The fields specify: (i) a requesting computer (EGD or EGS) identifier field 505 that (e.g., uniquely) identifies such device; (ii) a responding computer field 510 that indicates which EGS or combination of EGS's responded to a specific request; (iii) a request field 515 that indicates what request was made; (iv) a request parameters field 520 that indicates the specific parts of the request; (v) a response parameters field 525 that includes the specific response provided by the one or more EGS's identified I the responding computer field; (vi) a time of request field 530 that includes the date and the times at which the EDS or EGS's received their portions of the EGD request; and (vii) a transaction identifier field 535 that includes a unique transaction identifier associated with that request. The transaction identifier may include a unique EGD code that may identify a particular EGD plus an alphanumeric character field.

Of course, the audit database may include different and/or additional fields that store other information. Examples of other audit data that may be stored include, but are not limited to, the following: (i) data identifying the player who was using the EGD at the time of an event; (ii) other player related data; (iii) the end time of the response which indicates when each responding computer finished providing the requested data; and (iv) the software version used by each responding computer to provide the requested data. For example, when players insert player-tracking cards issued by a casino, data associated with their identities may be stored in the audit database with the gaming request audit data. Such operation may be beneficial, for example, because if an anomalous result occurs at a particular EGD at a particular time then the identity of the player who was playing that EGD at that time can be determined.

In an example, referring to row R500-1 of the Audit Database 500, a video poker machine named “Video Poker 1S” which may correspond to the video poker game device at location One-South on a gambling floor of a casino, made the request “Deal Poker Hand” and “Generating Five Random Numbers” (column 515). The request parameters are “Five Card Stud” and “Five Random Numbers” (column 520). In this example, referring to FIG. 2C, the EGD request from the

Video Poker 1S gaming device was transmitted to Load balance Device 105C and routed to Application Server A, which then transmitted the request for random numbers to Application Server E (row 500-1, column 510). Application Server E responded by generating five random numbers shown as 0.1, 0.57, 0.23, 0.72 and 0.43 (row 500-1, column 520) at 3:35:27 (column 530) and transmitted them to Application Server A, which mapped the random numbers into five cards: King hearts, 1 spades, Queen clubs, Queen diamonds, and 10 spades (column 525). The request for mapping occurred at 3:35:28 PM on Jan. 3, 2005 (column 530). Thus, the information in the Audit Database 500 is an audit trail which identifies the EGD making the request (Video Poker 1S), the identities of the physical EGS's (Application Server A and Application Server E) that responded, the type of request made by the EGD, the request parameters, the time of the requests, and a unique transaction identifier, which in this case is 7AVB88 (column 535).

In another example shown in row R500-2, “Video Slot Machine 5S” made the request to spin the reels and generate random numbers (column 515) and Application Server C and Application Server D together satisfied the requests. Application Server D generated the three required random numbers (0.67, 0.11 and 0.25, as shown in row 500-2 at column 525) at 9:27:16 PM (column 530), and Application Server C mapped the icons to the three reels (resulting in “Cherry, Bar, Bar”, as shown in row 500-2 at column 525) at 9:27:17 PM on Apr. 4, 2005 PM (row 500-2, column 530). The request parameters (column 520) included three random numbers and icons for three reels. The icons may have been chosen from known or typical game machine reel icons, for example, oranges, bars, cherries, stars and bells. In normal operation, the EGD displayed the game outcome on a payline of the reel slot machine. The unique transaction identifier generated for this request is 16LK09 (column 535).

It should be understood that the time of request entries shown in field 530 in the examples of rows R500-1 and R500-2 are for illustrative purposes and ease of understanding only. These times do not necessarily correlate to an actual amount of time spent processing an EGD request, for example. One skilled in the art would understand that the response time for an EGD request may be on the order of milliseconds or faster to ensure that a player experiences the expected game play feedback on an EGD.

In an embodiment, the requesting computer field 505, responding computer field 510, and at least one of the time of the request field 530 or transaction ID field 535 are required so that the Audit Database 500 can be used as a useful tool to check audit trails of EGD requests. In another embodiment, at least one of the request field 515 and/or the request parameters field 520 and/or the response parameters field 525 may be required. In some embodiments, one or more additional audit data fields may be included, such as the time of the response, and a calculated processing duration. Such data could be analyzed to determine whether one or more of the EGS's processed the data in an expected, expedient manner, and could be used as an indicator of the health of a particular gaming system of EGDs.

An Audit Database 500 may also be useful to either confirm or refute a claim by a player involving her game play at a particular EGD at a particular time. For example, the player may claim that a jackpot occurred on a particular video slot machine EGD that she was playing on Apr. 4, 2005 at 9:27 PM, but that she did not receive a payout or only received a partial payout. The Audit Database could be checked to see what gaming requests were made by that EGD at the time in question, and what responses were transmitted by which EGS's.

Moreover, such an audit database is a powerful tool for aiding in a quest to debug a problem in an EGD system. For example, if an intermittent but non-fatal error is occurring for only some EGDs in a system, the audit data for those EGDs could be reviewed to determine which other devices in the system supplied pertinent data. For example, if all versions of video poker software were updated such that a green background should appear on every EGD when a new hand is dealt, but some EGDs are still displaying red backgrounds occasionally, then the audit data for those EGDs displaying the red backgrounds during relevant time periods could be checked to determine which EGS or other device in the system processed requests and provided data for those EGDs. Such operation may lead an operator to suspect that a particular EGS seems to be responsible, and thus audit data for that EGS can be checked, and diagnostic software could be used to attempt to determine what might be the cause of the error. That EGS can also be checked by a technician to ensure that the software is operating correctly, and that there are no hardware failures.

Further, in some embodiments, the audit information may also include the software version installed on the physical device, such as an EGS, that was utilized at the time of the request. Such information may be critical when analyzing the audit data to resolve a software anomaly or to evaluate a claim of fraud by a player or other person. For example, a player may believe or perceive that gaming outcomes were not randomly generated at the particular EGD he was playing in a casino because of the losses the player incurred. The audit trail for that EGD corresponding to the date and time of play can then be located, and then the software version of the random number generator and other data checked to confirm that random numbers used to determine the gaming outcomes during that player's game play at that EGD for a specific duration were indeed randomly generated.

Therefore, it may be useful to know that Application Server D generated the random numbers and was running version 1.0.12 of the random number software at that time. The inclusion of such information in the Audit Database greatly simplifies the analysis of this data, because there is no longer a need to check the install records of a software distribution server and then infer which version of the random number software was installed at the moment of the request. When there are multiple machines in a gaming network that are organized in layers (see, for example, the Logical Server Layers 150 and 160 of FIG. 2C), it may be no small task to pinpoint the machine or machines in the network that may be the source of any particular problem.

The audit data may also include player identification data, including data that may potentially be associated with and/or accessed by the player. Thus, in one embodiment, players (or other users, such as authorized casino personnel, and/or regulators) may request (using an EGD, a peripheral device, a Web site, etc.) an “historical audit record/report” of EGD and EGS pairings data (e.g., audit data that is associated with at least one of a particular player, a time frame, an EGD, one or more EGS's, etc.). In some embodiments, a fee may be charged to a player, for example, to provide such a report. Alternately, such reports may only be provided to authorized personnel or to regulators.

In some embodiments, one or more users may “subscribe” to such reports, which would then be provided on a continual, periodic (e.g., weekly) or event-triggered basis (e.g., a report is generated and then provided to an authorized casino employee or to a regulator concerning a particular EGD after every 10,000 outcomes). Reports may be provided via Web interface, EGD display, kiosk, via email, sent to other communication devices (e.g. PDA's, cell phones and the like), and/or physically printed and mailed or delivered in other manner to a requesting party, or to casino personnel, or to a regulator, and the like. For example, a player may subscribe to receive daily reports at a particular hour of the day in her hotel room, which may be displayed on her room television screen or monitor, or on another analog or digital device configured to receive such reports (i.e. her cell phone or PDA).

There may be many other reasons why the audit trail may require analysis. For example, an anomaly may result in a software failure or financial record inconsistency, or a casino regulator may require that specific audit data concerning each EGD and/or each EGS in a network be kept and analyzed on an ongoing basis.

In some embodiments, the audit data may also include authenticable identifying information of the software. For example, a unique one-way hash of the installed software can be computed at the time of the request from an EGD and included in the audit information. In this manner, questions about whether the software is the unmodified authorized software can be resolved by comparing the software hash to the hash computed in the same manner on the authorized software.

In an embodiment, to prevent ex-post modification of audit data records that have been written to the Audit Database, the software used to write the data could hash the contents of one or more fields of the database to generate an additional hashed value. The hashed value could then be encrypted with the private key of a PKI algorithm known only to an authorized entity, such as the software manufacturer, a regulator, or casino operator. The encrypted hashed value could be stored in the audit database along with the gaming request audit data for each transaction. Thus, if one or more fields for a particular EGD request were maliciously modified in the Audit Database to cover up a fraud, for example, the perpetrator could not create a genuine hash from the modified data without the private key. Such a precaution would prevent a casino operator who is sitting at a display terminal in a casino control room(a potential perpetrator), for example, from modifying gaming data to enable an associate to win money and then later cover his tracks by modifying the audit data. For example, the casino operator could conspire with an associate to install adulterated gaming software for one hour so that his associate playing EGD1 on the gaming floor could commit fraud because the adulterated software generates multiple jackpots to occur for the associate. According to their plan, the casino operator then reinstalls the unadulterated software and attempts to cover his tracks by changing the audit data for that EGD in the Audit Database. Since the casino operator does not have access to the private key, he cannot create the appropriate encrypted hash output for any data that he modifies. Consequently, when the audit data for that EGD is checked, the a newly calculated hash of the modified data will not match the hash value that was originally calculated and stored in the audit database, and it will be apparent that the casino operator who was working during that time frame (or during a particular shift) defrauded the casino. In some embodiments, use of encryption on some or all of the audit data could also be utilized to make it even more difficult for an operator to perpetrate a fraud.

Such operation prevents an operator from covering his tracks after a malicious attack on the integrity of the system. Those skilled in the art of cryptography may suggest other ways to prevent modification of the contents of the Audit Database. For example, see the book entitled: “Applied Cryptography, Second Edition” by Bruce Schneier (John Wiley & Sons, Inc., 1996). This book discloses various methods for providing system security, and is incorporated in its entirety herein.

Graphical User Interface (GUI)

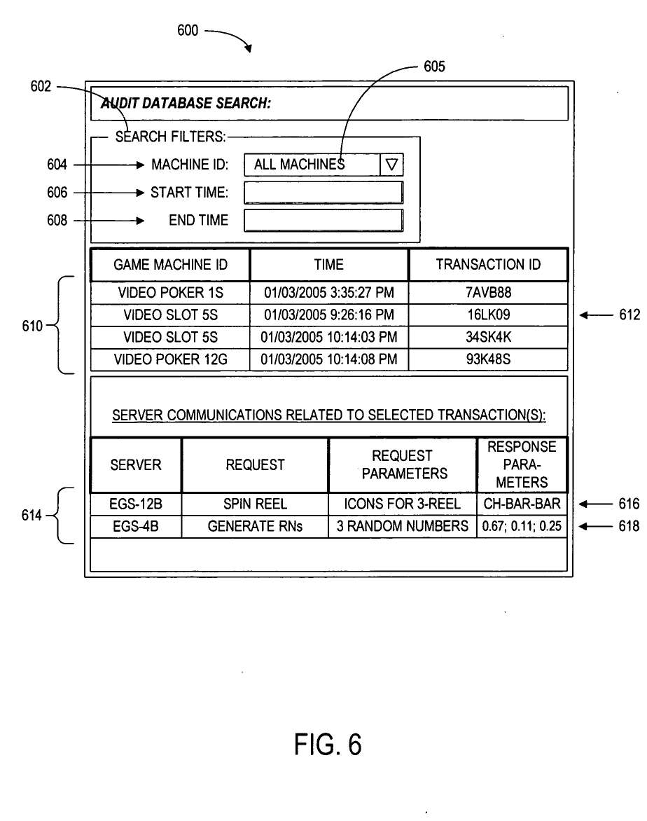

FIG. 6 is an embodiment of a graphical user interface (GUI) 600 for use in facilitating analysis of audit data. In some embodiments, regulators, casino personnel, and/or players may be provided with the software required to generate such a GUI. The GUI 600 could be a windows-based application, and may include Search Filters 602 such as a Machine ID field 604, a Start Time field 606 and an End Time field 608 that permit, for example, an authorized person to conduct a focused search for audit data corresponding to a particular device and/or a particular time frame. Once a search has been run, a table of search results 610 is presented. In the example of FIG. 6, an authorized person may use his computer cursor to highlight the row 612 for game machine ID “Video Slot 5S”, and by doing so cause details to be presented in a Server Communications area 614 related to that selected transaction. In particular, row 618 indicates that game server EGS-4B responded to a request for random numbers by supplying three random numbers, and row 616 indicates that game server EGS-12B responded to a spin reel request with response parameters “Cherry, Bar, Bar”. In other embodiments, different search screens (not shown) may be provided to permit other types of searches to be conducted, for example, by searching by transaction ID or EGS ID. In addition, various other data fields could be displayed in response to a search, for example, a field indicating the software version of the gaming software running on a particular EGS at the time of the selected transaction.

Additionally, or alternately, a menu-based system could be provided to allow easy access to, and to simplify the analysis of, the audit data. For example, a regulator may be able to use a personal computer to access a Central Audit Database residing on a server, and to display a menu of selections corresponding to various types of presentations of the audit data that may be of interest. For example, a website address may be provided for access by regulators having authorized login names and passwords. Once a regulator logs into the Audit Database system, he or she may be presented with various display options for viewing data based on various parameters. For example, the regulator may be prompted by the GUI to select to view the audit data by entering the name of one or more EGDs, or by entering the identifiers for one or more EGS's, or by entering a transaction identifier, or by entering a time of day and date, by entering another type of parameter, or by entering some combination of parameters.

It is also contemplated that the audit data could be inspected automatically. For example, an Audit Server may be configured to monitor and analyze audit data in real time as requests are being processed, or in post-processing. In such an embodiment, the audit server could automatically generate instructions for notifying appropriate casino personnel or regulators if certain events occur, and/or the audit server may possibly generate instructions to take automatic actions. For example:
(i) If the results generated by a physical EGS are greater than N percent of the results for a specific EGD, then do not allow that physical EGS to generate further outcomes for that EGD;
(ii) If greater than n % of player X's results have been generated by a physical EGS, then do not allow that physical EGS to generate further outcomes for that EGD until the percentage goes below Y %, or until Z amount of time has elapsed;
(iii) If the number of transaction IDs for a particular EGD or EGS is greater than x, then generate an audit report (as previously described above);
(iv) In embodiments wherein outcomes and player data are included in the audit database, if Outcome ID 101 has been achieved by player X more than a threshold number of times (i.e. in player X's total history, in last few days or game play, etc.), then automatically generate a report for casino personnel;
(v) In embodiments where outcomes and player data are included in the audit database, if Outcome ID 101 has been achieved by player X on any EGD in a network more than a threshold number of times (in total history, in last few days or game plays, etc.), and a physical EGS has generated the outcome more than a threshold percentage (of all possible EGS's in a network), then disallow that physical EGS and player X pairing;
(vi) Analyze data of EGD/EGS pairings and/or specific EGS and player pairings on a periodic basis to determine if there are any suspicious trends, and if so then disallow such pairings.

Regarding items (i) and (ii) above, the Audit Server would receive the audit data and automatically act to generate instructions to prevent suspicious gaming system behavior from continuing, possibly curtailing malicious code from being able to defraud the owners of the EGD system. A suspicious trend may include such behaviors as, for example, a specific EGS generating winning combinations for a particular EGD or group of EGDs at greater than a threshold percentage of game plays, and/or a particular EGD paying out a large number of jackpots within a short period of time, and/or a particular EGS generating greater than a threshold number of gaming request responses to a particular EGD within a predefined period of time. Item (iii) indicates that the Audit Server generates instructions for an audit report to be automatically generated after a threshold value of transactions is surpassed, which report may be automatically forwarded to, for example, a regulator and/or to authorized casino personnel. Regarding items (iv) and (v), “Outcome 101” may correspond to a minor jackpot award of, for example, a five-dollar payout, so that if such an outcome occurs for a particular player more than a predetermined threshold number of times, then a pairing of that player (at whatever EGD he is playing) and a particular EGS or Logical Server (i.e. a group of EGS's) is disallowed. For example, an Audit Server may generate instructions preventing Logical Server A from communicating with a particular EGD or for providing gaming outcomes for a particular player. Item (vi) indicates that, for example, data of EGD and EGS pairings or specific EGS and player pairings are gathered and analyzed at periodic intervals to determine if any suspicious trends can be detected, and if so then the suspect pairings are disallowed from occurring in the future for at least some predetermined amount of time.

Those skilled in the art can readily utilize the systems and methods disclosed herein to gather various different types of audit data and/or parameters and use such information to perform various analyses to generate informative and desirable gaming intelligence. As is also apparent from the above descriptions, such audit data may be analyzed and the results utilized to take appropriate actions, such as by automatically generating reports and/or by automatically disallowing certain events from occurring in the future. One skilled in the art would understand that such audit data could also be used for further processing to obtain other or different information, which information may be used to take various automatic actions, and/or to inform authorized persons so that they can take action if desired.

Thus, the methods and systems of the present invention are operable to generate audit data defining an audit trail of EGD requests across multiple physical EGS's. In an embodiment, the audit trail is saved in a Central Audit Database and includes identifying information to associate the data with each EGD in a system. Consequently, sufficient information is generated so that a regulator or authorized casino personnel can, for example, analyze the audit data to investigate any anomalous results, claims to winnings, and/or other events, and determine which physical EGS or combination or EGS's participated in generating the particular outcomes or results of interest. In some embodiments, cryptographic methods are utilized to prevent tampering with the audit data by a malicious person, which may include a casino operator having access to the audit database.

Applicants have recognized that it would be beneficial for casino regulators and others to have a system and method for easily and quickly obtaining audit trail information concerning each EGD and/or each EGS and/or each of the other devices of a system so that various events, such as EGD requests, EGS gaming results, payouts, anomalies, and other events can be reviewed to ensure, for example, that no fraud has occurred. As noted above, to simplify the analysis of such information, and to display it in an easy to understand format, a graphics user interface (GUI) and/or a menu-driven system could be used. For example, a casino regulator could use the GUI or the menu system to access and to review selected portions of the audit data in an Audit Database, perhaps focusing on a particular EGD or group of EGDs in a particular time frame. The audit trail information could also be used to spot and analyze trends to provide valuable information regarding the functioning of the devices that comprise a gaming system.

Rules of Interpretation

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise. The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus; other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3 features. G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning. Finally, unless a claim element is defined by reciting the word “means” and a function without reciting any structure, it is not intended that the scope of any claim element be interpreted based on the application of 35 U.S.C. §112, sixth paragraph.

Although the present invention has been described with respect to preferred embodiments thereof, those skilled in the art will note that various substitutions and modifications may be made to those embodiments described herein without departing from the spirit and scope of the present invention.

What is claimed is:

1. A method for auditing the performance of a plurality of electronic game devices of a system, comprising:
determining gaming request audit data for at least one of a plurality of electronic game devices, the gaming request audit data including an electronic game device identifier, at least one electronic game server identifier corresponding to at least one responsive electronic game server, and at least one of an indication of the time of a gaming request and a transaction identifier; and
storing the gaming request audit data In at least one searchable memory,

2. The method of claim 1, wherein the gaming request audit data further comprises at least one of:
an indication of the gaming request,
request parameters,
response parameters,
an indication of at least one function performed by the electronic game device,
a software version identifier indicating the level of software utilized by at least one of the at least one responsive electronic game server and the electronic game device,
an encrypted cryptographic hash of at least one data item associated with the gaming request audit data, and
a processing time corresponding to the period of time utilized to process the gaming request.

3. The method of claim 1, which further comprises storing the gaming request audit data in a memory of at least one of a dedicated storage device, at least one electronic game device, at least one electronic game server, and an audit server.

4. The method of claim 1, which further comprises storing gaming request audit data in the memory as players utilize the plurality of electronic game devices.

5. The method of claim 1, which further comprises storing gaming request audit data in the memory at least one of several times per day, once per day, on a predetermined periodic basis, at all times, and on command.

6. The method of claim 1, which further comprises storing gaming request audit data in the memory according to at least one of a full audit mode of operation and a standard audit mode of operation.

7. The method of claim 1, in which storing further comprises transmitting gaming 0 request audit data for storage in the memory from at least one of a predetermined device, pre-selected devices, all of the devices in the system, and only the plurality of electronic game devices.

8. The method of claim 1, which further comprises storing at least a portion of the gaming request audit data in a memory of each of the plurality of electronic game devices.

9. The method of claim 8, which further comprises periodically transmitting the gaming request audit data in the memory of the electronic game devices to a central audit database.

10. The method of claim 1, which further comprises storing at least a portion of the gaming request audit data in a memory of each electronic game device and in a memory of each electronic game server in the system.

11. The method of claim 10, which further comprises periodically transmitting the gaming request audit data in the memory of the electronic game devices and in the memory of the electronic game servers to a central audit database.

12. The method of claim 10, which further comprises transmitting the gaming request audit data from the electronic game devices and the electronic game servers to a central audit database as gaming requests are processed.

13. The method of claim 1, further comprising securing the memory to prevent at least one of unauthorized access to, and modification of, the gaming request audit data.

14. The method of claim 13, which further comprises providing access to at least a portion of the gaming request audit data in the secured memory to at least one of authorized casino personnel, a regulator, and a player.

15. The method of claim 1, further comprising:
hashing at least a portion of the gaming request audit data;
encrypting the hashed data with a private key; and
storing the encrypted hashed value in the memory.

16. The method of claim 15, further comprising verifying the stored gaming request audit data by comparing the stored encrypted hashed value to a new hashed value calculated by an authorized entity using the private key.

17. The method of claim 16, wherein the authorized entity is at least one of a casino employee, a regulator and a software manufacturer.

18. The method of claim 15, which further comprises:
selecting gaming request audit data stored in the memory that corresponds to a transaction;
performing a hash calculation on at least a portion of the selected gaming request audit data;
decrypting the stored encrypted hashed value with an appropriate public key; and
comparing the calculated hash value to the decrypted hash value for that transaction to verify the authenticity of that stored gaming request audit data.

19. The method of claim 1, in which storing further comprises storing the gaming request audit data in at least one of a tabular form, in an object-oriented format, in an XML format, and in a relational database format.

20. The method of claim 1, further comprising:
analyzing the gaming request audit data for at least one transaction; and
generating at least one instruction based on the analysis.

21. The method of claim 20, which further comprises responding to the at least one instruction by at least one of generating a report and disallowing at least one event from occurring.

22. The method of claim 20, which further comprises responding to the at least one instruction by limiting communications between at least one device in the system and an electronic game device.

23. The method of claim 22, which further comprises allowing the communications between the at least one device and the electronic game device when a predetermined condition is satisfied.

24. The method of claim 23, wherein the predetermined condition comprises exceeding at least one of a predetermined amount of time and a predetermined threshold value.

25. The method of claim 1, further comprising:
analyzing the gaming request audit data for a plurality of transactions; and
recognizing a suspicious trend based on the analysis.

26. The method of claim 25, further comprising automatically taking at least one action when the suspicious trend is recognized.

27. The method of claim 26, wherein the at least one action comprises at least one of generating at least one report and disallowing at least one communication between a device in the system and at least one electronic gaming device.

28. A system for auditing the performance of electronic game devices of a network, comprising:
a plurality of electronic game devices, at least one of the electronic game devices configured to make at least one gaming request to another device;
at least one logical application server configured to receive and to respond to gaming requests; and
at least one memory configured to obtain and to store gaming request audit data of the plurality of electronic game devices, wherein the gaming request audit data for each gaming request includes data identifying the electronic game device, data identifying all other communicating devices, and at least one of the time and date of the game request and a transaction identifier.

29. The system of claim 28, wherein the at least one memory is associated with at least one of the plurality of electronic game devices, and at least one electronic game server of the at least one logical application server.

30. The system of claim 28, wherein the at least one memory comprises at least one of a central audit database and a storage device of an audit server.

31. The system of claim 28, further comprising at least one of a load balance device and a director device configured to allocate game requests from the electronic game devices to at least one electronic game server of the at least one logical application server.

32. The system of claim 28, further comprising at least one display device configured to communicate with the at least one memory and to display gaming request audit data.

33. The system of claim 32, which further comprises a software program configured to permit a user of the at least one display device to access and to search the at least one memory.

34. The system of claim 33, wherein the software program further comprises at least one of a graphical user interface and a menu system.

35. The system of claim 28, which further comprises an audit server having the at least one memory and configured to automatically analyze the gaming request audit data and to generate at least one instruction for taking at least one action based on the analysis.

36. The system of claim 35, wherein the at least one instruction causes at least one of a report to be generated and disallows at least one device in the network from communicating with at least one electronic game device.

37. The system of claim 28, further comprising at least one of a peripheral device, a smart card, a USB key device, a personal digital assistant, and a casino personnel device configured to access the at least one memory and to obtain at least a portion of the gaming request audit data.

38. A method, comprising:
transmitting gaming request audit data from at least one of a plurality of devices in a gaming system;
receiving the gaming request audit data at a central audit database, the gaming request audit data comprising an electronic game device identifier of the device that made the game request, at least one electronic game server identifier of at least one responsive electronic game server, and at least one of a time and date of the game request and a transaction identifier; and
storing the gaming request audit data.

39. The method of claim 38, further comprising:
hashing at least a portion of the gaming request audit data;
encrypting the hashed data with a private key of an authority; and
storing the encrypted hashed data in the memory.

40. The method of claim 39, wherein the authority is at least one of a casino operator, a regulator, and a manufacturer.

41. The method of claim 38, which further comprises:
selecting gaming request audit data stored in the central audit database that corresponds to a transaction;
hashing at least one game request component for the transaction;
decrypting the stored encrypted hash with an appropriate public key; and
comparing the calculated hash to the decrypted stored hash to verify the authenticity of the stored gaming request audit data for that transaction.

42. The method of claim 38, which further comprises storing gaming request audit data in the audit database according to at least one of a full audit mode of operation and a standard audit mode of operation.

43. An apparatus, comprising:
a processor operable to communicate with at least one of a plurality of devices of a gaming system; and
a memory storing a program to direct the processor to obtain gaming request audit data according to the method of claim 1.

44. The apparatus of claim 43, wherein the apparatus is an audit module configured for installation to a device of a gaming system.

45. A computer-readable medium configured to store instructions for directing a processor to audit the performance of each of a plurality of electronic game devices connected in a system, the instructions causing the processor to:
obtain gaming request audit data that includes an electronic game device identifier, at least one electronic game server identifier corresponding to at least one responsive electronic game server, and at least one of an indication of the time and date of the request and a transaction identifier; and
store the gaming request audit data in at least one searchable memory.
